(19) United States
(12) Patent Application Publication
(10) Pub. No.: US 2003/0074098 A1
(43) Pub. Date: Apr. 17, 2003

(54) Integrated equipment set for forming an interconnect on a substrate

(76) Inventors: Robin W. Cheung, Cupertino, CA (US); Suketu A. Parikh, San Jose, CA (US); Pierre G. Hraiz, Fremont, CA (US)

Correspondence Address: PATENT COUNSEL, APPLIED MATERIALS, INC., Legal Affairs Department, P.O. BOX 450A, Santa Clara, CA, 95052, US

(21) Appl. No.: 10/247,773

(22) Filed: Sep. 16, 2002

Related U.S. Application Data
(60) Provisional application No. 60/323,065, filed on Sep. 18, 2001.

(51) Int. Cl. G06F 19/00

(52) U.S. Cl. 700/121; 700/164

(57) ABSTRACT

A method is provided that includes (1) receiving information about a substrate processed within a barrier/seed layer deposition subsystem from an integrated inspection system of the subsystem; (2) determining an electroplating process to perform within an electroplating subsystem based at least in part on the information received from the inspection system of the barrier/seed layer deposition subsystem; (3) directing the electroplating subsystem to deposit a fill layer on the substrate based on the electroplating process; (4) receiving information about the fill layer from an integrated inspection system of the electroplating subsystem; (5) determining a planarization process to perform within a planarization subsystem based at least in part on the information received from the inspection system of the electroplating subsystem; and (6) directing the planarization subsystem to planarize the substrate based on the planarization process. Other methods, systems, apparatus, data structures and computer program products are provided.

This application claims priority from U.S. Provisional Patent Application Serial No. 60/323,065, filed Sep. 18, 2001, which is hereby incorporated by reference herein in its entirety.

### FIELD OF THE INVENTION

The present invention relates to semiconductor device manufacturing, and more specifically to an integrated equipment set for forming an interconnect on a substrate.

### BACKGROUND OF THE INVENTION

A typical integrated circuit contains a plurality of metal pathways that provide electrical power for powering the various semiconductor devices forming the integrated circuit, and that allow these semiconductor devices to share/exchange electrical information. Within integrated circuits, metal layers are stacked on top of one another by using intermetal or “interlayer” dielectrics that insulate the metal layers from each other.

Generally, each metal layer must form electrical contact to at least one additional metal layer. Such metal-layer-to-metal-layer electrical contact is achieved by etching a hole (i.e., a via) in the interlayer dielectric that separates the metal layers, and by filling the resulting via with a metal to create an interconnect as described further below. Metal layers typically occupy etched pathways or “lines” in the interlayer dielectric. When copper metal layers and copper interconnects are employed, because copper atoms are highly mobile in silicon dioxide and may create electrical defects in silicon, the copper metal layers and interconnect vias conventionally are encapsulated with a barrier material (e.g., to prevent copper atoms from creating leakage paths in silicon dioxide interlayers and/or defects in the silicon substrate on which the metal layers and interconnects are formed).

As is well known, an increase in device performance is typically accompanied by a decrease in device area or an increase in device density. An increase in device density requires a decrease in the via and line dimensions used to form interconnects (e.g., a larger depth-to-width ratio or a larger “aspect ratio”). Decreased via and line dimensions require tighter control over the etching process used to form each via or line, the deposition process or processes used to fill each via or line and the planarization process employed thereafter.

Many conventional interconnect formation techniques rely on the use of “process windows”. A process window is an estimated range of one or more parameters that typically result for a given process (e.g., an estimated range of via or line depths and/or widths that typically result for a given etch process, an estimated range of film thicknesses that typically result for a given deposition process, etc.). Accordingly, when process windows are employed, vias and lines typically are overetched to ensure that all interlayer material to be removed is removed, vias and lines typically are overfilled to ensure that the deepest or widest vias and lines are adequately filled, and substrates typically are overpolished during planarization to ensure that planarization is complete. The use of process windows thereby reduces device uniformity (due to the inherent inaccuracy of using predicted/estimated via/line dimensions, deposited film thicknesses, etc.) and decreases throughput (due to overprocessing).

To ensure that each process step used during interconnect formation (e.g., etching, barrier/seed layer deposition, electroplating, planarization, etc.) maintains its proper process window, “test” substrates may be periodically analyzed following each interconnect process step. For example, following an etch process, a test substrate may be analyzed within a stand alone metrology tool that measures via and/or line depth, width, profile, uniformity across a substrate or the like. Similarly, a stand alone metrology tool may be employed to measure deposited film thickness, and stand alone defect detection tools may be used to measure defect levels following etching, deposition and planarization. In this manner, if etched dimensions and/or deposited film thicknesses are outside of a required process window, or if too many defects result following etching, deposition and/or planarization, appropriate corrective measures may be taken so that each interconnect process (e.g., etching, deposition and/or planarization) produces results within its required process window.

The use of test substrates results in at least one major drawback. Namely, due to the time required to examine and analyze each test substrate following etching, deposition or planarization, such test wafers may only be employed periodically without significantly affecting the throughput of the various semiconductor processing tools used during interconnect formation (e.g., etching tools, deposition tools, planarization tools, etc.). Numerous substrates thereby may be processed using out of specification process windows before the out of specification process windows are identified with test substrates. High scrap costs result.

The need for more automated, direct control over semiconductor device fabrication processes has been previously recognized. For example, J. Baliga, “Advanced Process Control: Soon to be a Must”, Semiconductor International, pp.1-10 (July 1999) discusses potential benefits of employing advanced process control (APC) during semiconductor device manufacturing. However, as this article describes, the conventional use of APC has been (1) limited to only a few areas (e.g., chemical mechanical planarization (CMP), lithography, etc.); (2) limited to relatively simple applications (e.g., CMP, lithography, etc.); and (3) employed primarily at a process level (e.g., feedback for a single process), not at a system level (e.g., not at a level that affects numerous sequential processing steps such as those employed during interconnect formation). APC has not been used at a level that affects numerous processes and also that depends on the coordination of a number of discreet subsystems and technologies. Conventional APC techniques have had little, if any, affect on overall interconnect formation strategies; and the use of test substrates and process windows during interconnect formation remains widespread.

Accordingly, a need exists for improved methods and apparatus for forming interconnects on a substrate.

### SUMMARY OF THE INVENTION

In a first aspect of the invention, a novel system is provided for forming an interconnect on a substrate. The system includes (1) a barrier/seed layer deposition subsystem configured to deposit a barrier layer and a seed layer on a substrate, the barrier/seed layer deposition subsystem having an integrated inspection system configured to inspect the substrate; (2) an electroplating subsystem configured to receive the substrate after the seed layer has been deposited on the substrate and to deposit a fill layer on the substrate, the electroplating subsystem having an integrated inspection system configured to inspect the substrate; (3) a planarization subsystem configured to receive the substrate after the fill layer has been deposited on the substrate and to planarize the substrate; and (4) a controller coupled to the barrier/seed layer deposition subsystem, the electroplating subsystem and the planarization subsystem.

The controller includes computer program code configured to communicate with each subsystem and to perform the steps of (1) receiving information about a substrate processed within the barrier/seed layer deposition subsystem from the inspection system of the barrier/seed layer deposition subsystem; (2) determining an electroplating process to perform within the electroplating subsystem based at least in part on the information received from the inspection system of the barrier/seed layer deposition subsystem; (3) directing the electroplating subsystem to deposit a fill layer on the substrate based on the electroplating process; (4) receiving information about the fill layer deposited on the substrate from the inspection system of the electroplating subsystem; (5) determining a planarization process to perform within the planarization subsystem based at least in part on the information received from the inspection system of the electroplating subsystem; and (6) directing the planarization subsystem to planarize the substrate based on the planarization process. Numerous other systems, methods, computer program products and data structures also are provided. Each computer program product described herein may be carried by a medium readable by a computer (e.g., a carrier wave signal, a floppy disc, a compact disc, a DVD, a hard drive, a random access memory, etc.).

In another aspect of the invention, a system for forming an interconnect on a substrate is provided that includes (1) means for determining a deposition process to perform within a barrier/seed layer deposition subsystem; (2) means for directing the barrier/seed layer deposition subsystem to perform the deposition process so as to deposit a material layer on a substrate; (3) means for receiving information about the deposited material layer from an integrated inspection system of the barrier/seed layer deposition subsystem; (4) means for determining an electroplating process to perform within an electroplating subsystem based at least in part on the information received from the inspection system of the barrier/seed layer deposition subsystem; (5) means for directing the electroplating subsystem to deposit a fill layer on the substrate based on the electroplating process; (6) means for receiving information about the fill layer deposited on the substrate from an integrated inspection system of the electroplating subsystem; (7) means for determining a planarization process to perform within a planarization subsystem based at least in part on the information received from the inspection system of the electroplating subsystem; and (8) means for directing the planarization subsystem to planarize the substrate based on the planarization process.

Other features and aspects of the present invention will become more fully apparent from the following detailed description, the appended claims and the accompanying drawings.

### BRIEF DESCRIPTION OF THE DRAWINGS

FIG. 1A is a schematic diagram of an inventive system for forming interconnects on a substrate in accordance with the present invention;

FIG. 1B illustrates an alternative embodiment to the system of FIG. 1A wherein the module controller of FIG. 1A is “distributed” among a number of subsystems;

FIG. 2 is a schematic diagram of an exemplary embodiment of the module controller of FIGS. 1A and 1B;

FIG. 3 is a top plan view of an exemplary embodiment of the barrier/seed layer deposition subsystem of FIGS. 1A and 1B;

FIG. 4 is a top plan view of an exemplary embodiment of the electroplating subsystem of FIGS. 1A and 1B;

FIG. 5A is a top plan view of a first exemplary embodiment of the planarization subsystem of FIGS. 1A and 1B;

FIG. 5B is a top plan view of a second exemplary embodiment of the planarization subsystem of FIGS. 1A and 1B;

FIGS. 6A-E illustrate a flowchart of an exemplary process for forming interconnects on a substrate in accordance with the present invention;

FIGS. 7A-E are cross-sectional views illustrating the formation of an exemplary interconnect formed in accordance with the process of FIGS. 6A-E;

FIG. 8A is a table of exemplary process parameters of a barrier/seed layer deposition subsystem that may be adjusted based on feedforward and/or feedback information in accordance with the present invention;

FIG. 8B is a table of exemplary process parameters of an electroplating subsystem that may be adjusted based on feedforward and/or feedback information in accordance with the present invention; and

FIG. 8C is a table of exemplary process parameters of a planarization subsystem that may be adjusted based on feedforward and/or feedback information in accordance with the present invention.

### DETAILED DESCRIPTION

### Overview of Integrated Interconnect Manufacturing

The present invention provides integrated methods, apparatus, systems, data structures and computer program products for forming interconnects on a substrate. The substrate may be a semiconductor substrate (e.g., a semiconductor wafer) or any other suitable substrate such as a glass plate for flat panel displays.

In one aspect of the invention, a novel system is provided that includes a subsystem capable of depositing both a barrier layer and a seed layer (hereinafter a “barrier/seed layer deposition subsystem”) having an integrated inspection system, an electroplating subsystem having an integrated inspection system, a planarization subsystem having an integrated inspection system and a module controller for controlling interconnect formation via these subsystems. Each integrated inspection system is capable of performing defect detection (e.g., to detect defect density on a surface of a substrate after a processing step) and/or metrology (e.g., to measure deposited layer thicknesses, surface planarity, etc., after a processing step).

To form an interconnect on a substrate, the substrate is delivered to the inventive system with an interlayer dielectric that is patterned so as to define “interconnect” regions or features in the interlayer dielectric where interconnects are to be formed (e.g., single or dual damascene structures such as lines and/or vias). For example, the substrate may be delivered to the inventive system from a conventional etch tool.

Within the inventive system, the substrate is transferred to the barrier/seed layer deposition subsystem, and the integrated inspection system of the barrier/seed layer deposition subsystem may perform defect detection on the substrate (e.g., to ensure that the substrate does not have too high of a defect density) and/or metrology on the substrate (e.g., to ensure that the interconnect features have been properly formed/patterned and/or to determine interconnect feature density and/or dimensions/profile). Based at least in part on “feedforward” information about the substrate such as defect density or interconnect feature density/dimensions/profile, the module controller may determine a barrier layer deposition process and a seed layer deposition process to perform within the barrier/seed layer deposition subsystem. The barrier and/or seed layer deposition processes also may be determined based at least in part on other information such as information received from the integrated inspection system of the barrier/seed layer deposition subsystem for a substrate previously processed within the barrier/seed layer deposition subsystem (e.g., “feedback” information such as barrier layer thickness, seed layer thickness, defect density, etc., for a previously processed substrate). The module controller then directs the barrier/seed layer deposition subsystem to perform the determined deposition process or processes (e.g., so as to deposit a barrier layer and a seed layer on the substrate).

Once the barrier layer and the seed layer have been deposited on the substrate, the substrate is inspected within the integrated inspection system of the barrier/seed layer deposition subsystem to determine deposited layer thicknesses (e.g., the thickness of the deposited barrier layer and/or of the deposited seed layer), defect density, etc., and this information is communicated to the module controller. Thereafter, the substrate is transferred to the electroplating subsystem and a fill layer is deposited on the substrate (e.g., so as to fill remaining portions of vias and trenches to form the conductive lines and plugs of the interconnect features).

To deposit the fill layer, the module controller determines and directs the electroplating subsystem to employ an electroplating process that may be based at least in part on dimension and/or profile information regarding the interconnect features present on the substrate (previously measured for the substrate by the integrated inspection system of the barrier/seed layer deposition subsystem). The electroplating process also may be based at least in part on information obtained from the integrated inspection system of the electroplating subsystem for a substrate previously processed within the electroplating subsystem (e.g., information such as fill layer thickness, defect density, etc., for a previously processed substrate), or the electroplating process may be based at least in part on information gathered by the integrated inspection system of the electroplating subsystem prior to processing.

Once the fill layer has been deposited on the substrate, the substrate is inspected with the integrated inspection system of the electroplating subsystem (e.g., to determine fill layer thickness, defect density, etc.), and inspection information is communicated to the module controller. The substrate then is transferred to the planarization subsystem and is planarized.

To planarize the substrate, the module controller determines and directs the planarization subsystem to employ a planarization process that may be based at least in part on the thickness of the fill layer deposited on the substrate as obtained from the integrated inspection system of the electroplating subsystem and/or that may be based at least in part on information obtained from the integrated inspection system of the planarization subsystem for a substrate previously processed therein (e.g., information such as defect density, surface planarity following planarization, etc.) or from the incoming substrate itself. Once the substrate has been planarized, the substrate is inspected with the integrated inspection system of the planarization subsystem (e.g., to determine defect density, surface planarity, etc.), and this inspection information is communicated to the module controller.

Numerous other aspects of the invention also are provided. The module “controller” may be a single, central controller that communicates with the integrated inspection system of each subsystem, or each subsystem may include controller capabilities (e.g., the module controller may be distributed among the subsystems such that each subsystem has a controller that communicates with one or more other subsystem controllers). In at least one embodiment, each subsystem includes an embedded module controller and an automated process control module (e.g., computer program code) that may communicate with the integrated inspection system of the subsystem and with embedded module controllers of other subsystems, determine processes to perform within the subsystem based at least in part on feedback information (e.g., from the integrated inspection system of the subsystem) and/or feedforward information (e.g., from an embedded module controller of another subsystem), etc., as described in more detail below.

Because during interconnect formation, each process performed (e.g., low k interlayer dielectric deposition, etching, barrier/seed layer deposition, electroplating, planarization, etc.) may be based at least in part on feedforward information (e.g., patterned masking layer density, interconnect feature density, defect density, interconnect feature dimensions/profile, deposited layer thickness, etc., for the substrate to be processed) and/or based at least in part on feedback information (e.g., defect density, interconnect feature dimensions/profile, deposited layer thickness, etc., for a substrate previously processed), the use of “estimated” process windows during low k dielectric interconnect formation may be reduced, and the accuracy and repeatability of each process step may be significantly increased. Additionally, the integrated nature of each inspection system allows substrates to be inspected without significantly affecting subsystem throughput (e.g., every substrate processed may be inspected).

### Relevant Terminology

As used herein, an integrated inspection system refers to an inspection system that is (1) coupled to a fabrication subsystem; and (2) capable of inspecting one substrate of a batch of substrates delivered to the fabrication subsystem during at least a portion of the time that another substrate of the batch of substrates is processed within the fabrication subsystem. A fabrication subsystem may include any known semiconductor device fabrication tool, system or subsystem such as an etch tool, a deposition tool, a cleaning tool, an oxidation tool, a planarization tool or the like. A stand alone inspection system refers to an inspection system that is (1) not coupled to a fabrication subsystem; and/or (2) incapable of inspecting one substrate of a batch of substrates delivered to the fabrication subsystem during at least a portion of the time that another substrate of the batch of substrates is processed within the fabrication subsystem.

An inspection system refers to a system capable of performing defect detection or metrology. Defect detection refers to the detection, identification and/or classification of defects, contaminants, flaws, imperfections, deficiencies or the like. Metrology refers to the determination of one or more material or process parameters such as thickness, composition, index of refraction, atomic structure, mechanical properties, electrical properties, dimension, profile, gas pressure, process temperature, gas flow rates, pump rate or the like.

Determining may include selecting, calculating, computing, defining, delineating, measuring or the like. Directing may include applying, initiating, controlling, managing, assisting or the like. Configured to or adapted to may include formed to, designed to, selected to, constructed to, manufactured to, programmed to or the like. Communication may include one or two way communication, polling, or the like. Feedback information refers to information regarding a substrate (e.g., defect density, material properties such as trench depth, trench width, trench profile, thickness, etc.) that is relevant to at least the processing of a subsequent substrate. Feedforward information refers to information regarding a substrate that is relevant to at least the subsequent processing of the same substrate.

### System Apparatus Overview

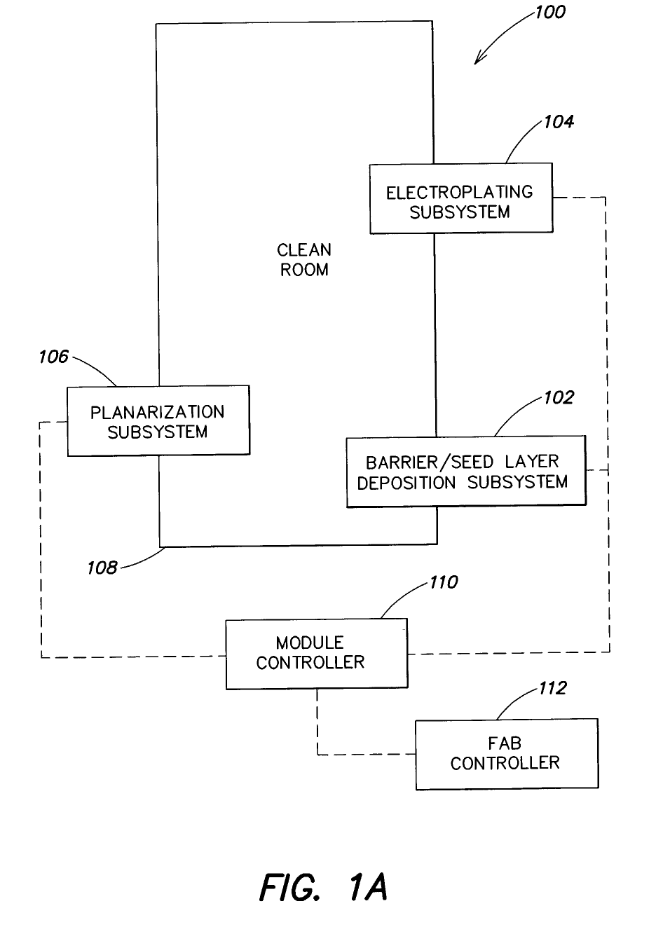

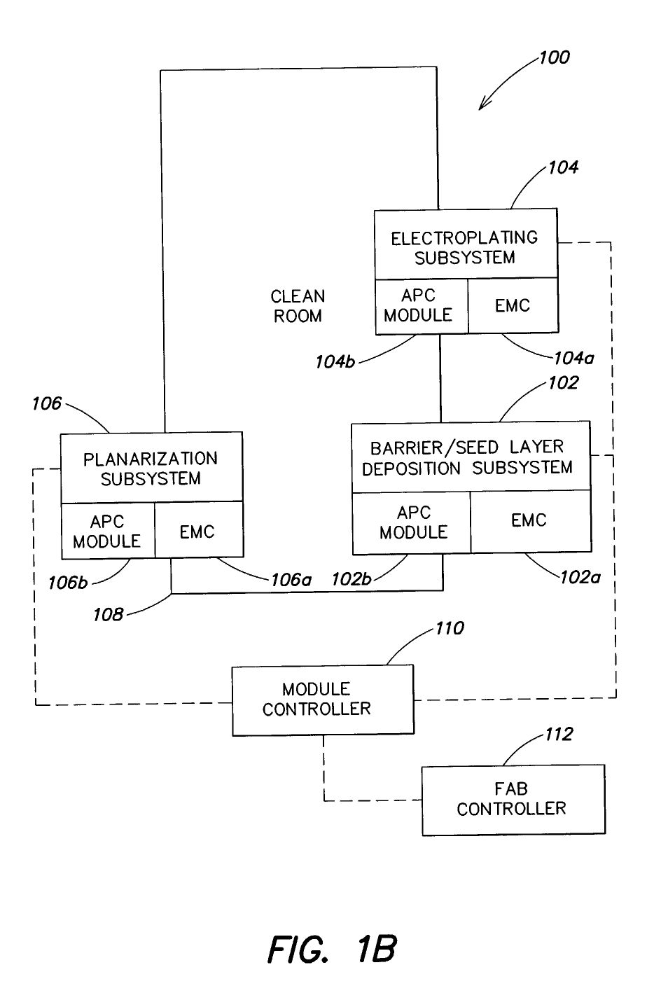

FIG. 1A is a schematic diagram of an inventive system 100 for forming interconnects on a substrate in accordance with the present invention. With reference to FIG. 1A, the inventive system 100 includes a barrier/seed layer deposition subsystem 102, an electroplating subsystem 104, and a planarization subsystem 106 each located at least partially within a clean room 108. Each subsystem 102-106 is in communication with a module controller 110 which is in turn in communication with a fabrication (FAB) host/controller (referred to as FAB controller 112), both described in more detail below. One or more of the subsystems 102-106 also may be in communication with the FAB controller 112. More than one module or FAB controller also may be employed, as may additional/redundant processing subsystems (e.g., additional/redundant barrier/seed layer deposition subsystems, electroplating subsystems, planarization subsystems, etc.).

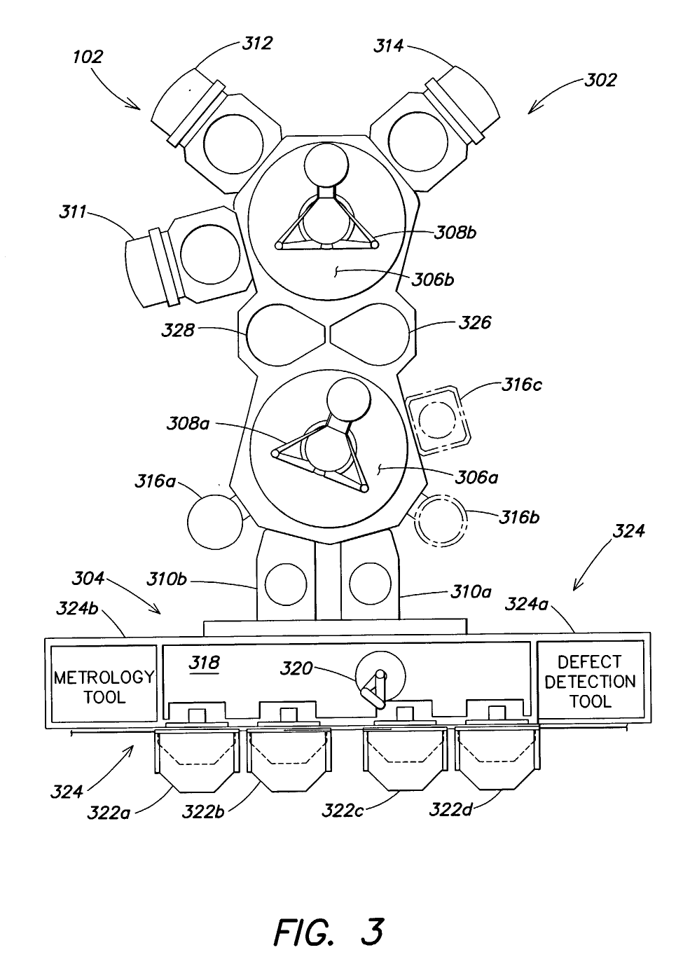

The barrier/seed layer deposition subsystem 102 may comprise any apparatus capable of depositing a barrier layer and a seed layer on a substrate and that includes an integrated inspection system for inspecting substrates processed within the barrier/seed layer deposition subsystem 102. One exemplary embodiment of the barrier/seed layer deposition subsystem 102 is described below with reference to FIG. 3.

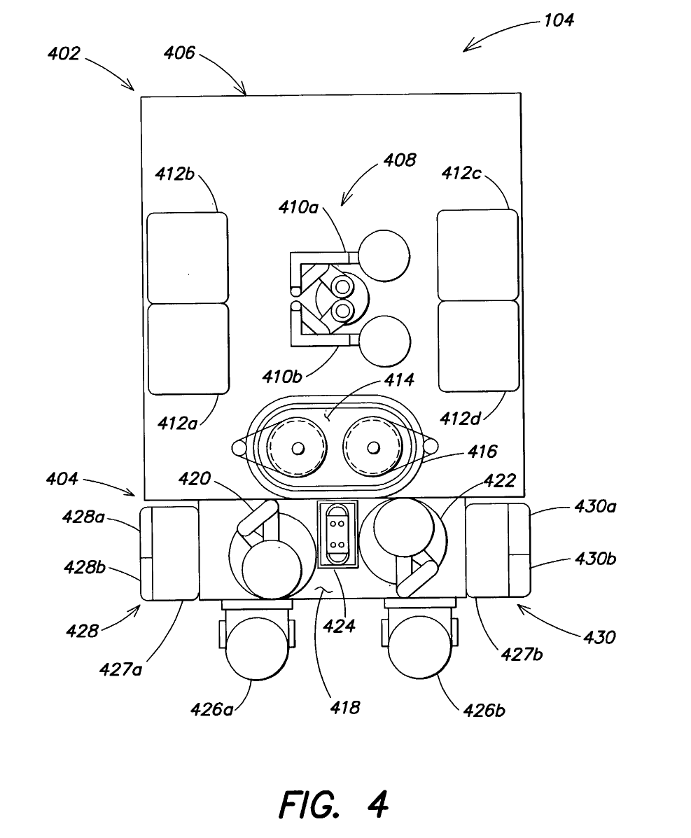

The electroplating subsystem 104 may comprise any apparatus capable of depositing a fill layer (e.g., copper or some other metal) within an interconnect feature of a substrate. One exemplary embodiment of the electroplating subsystem 104 is described below with reference to FIG. 4.

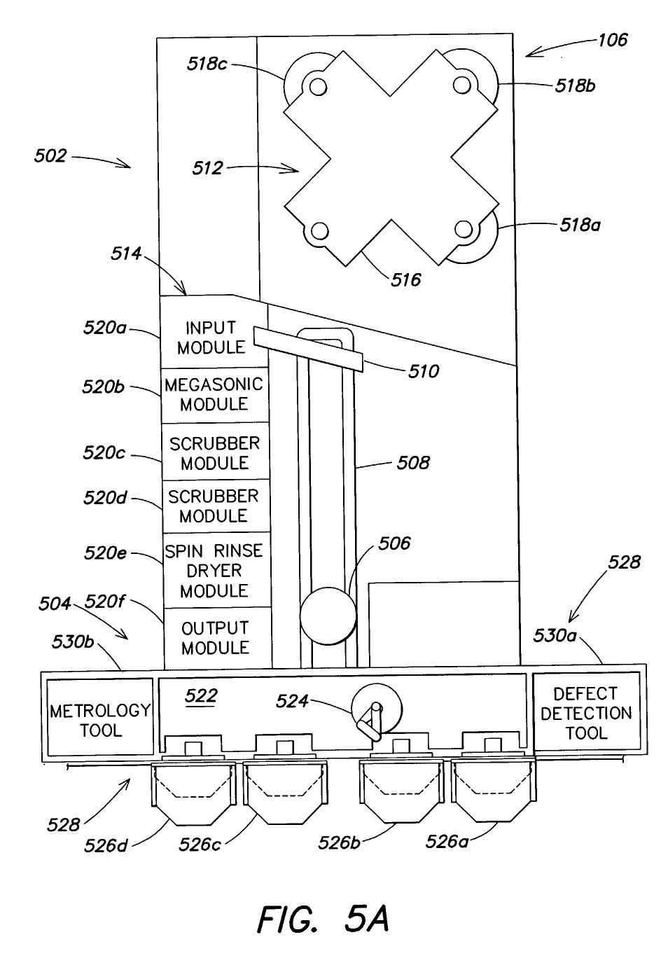

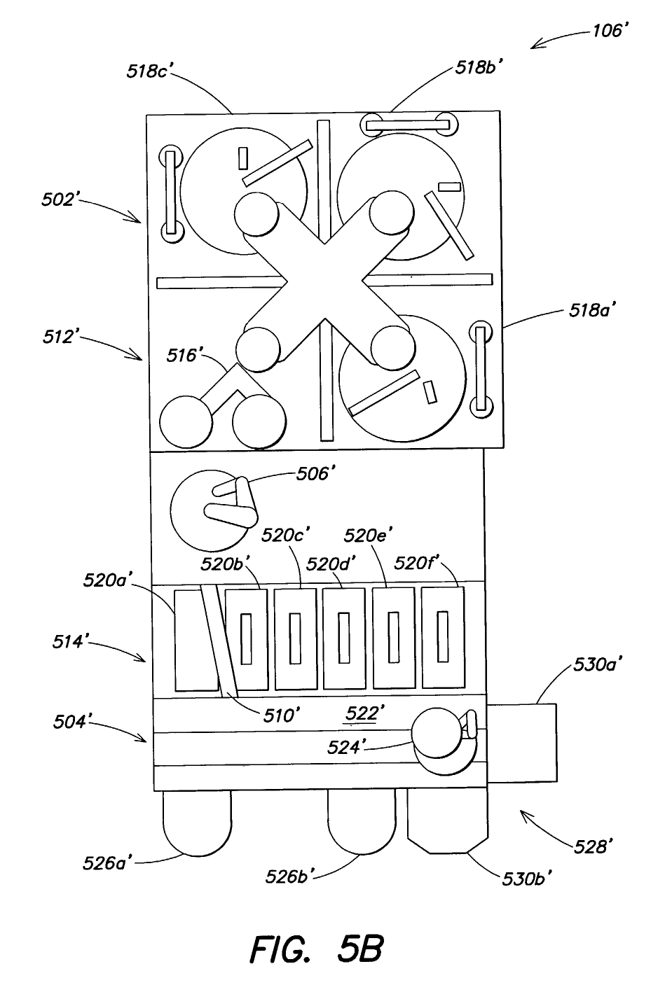

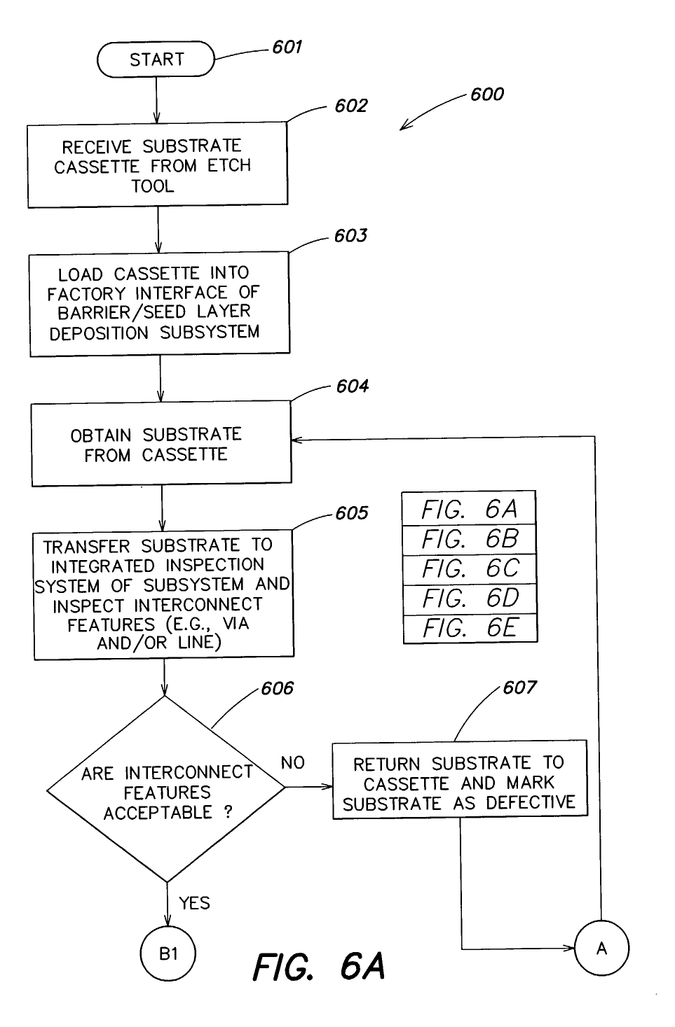

The planarization subsystem 106 may comprise any apparatus capable of planarizing a substrate following deposition of a fill layer on the substrate via the electroplating subsystem 104. Exemplary embodiments of the planarization subsystem 106 are described below with reference to FIGS. 5A and 5B. The clean room 108 may comprise any suitable clean room facility such as a class 1 clean room. The subsystems 102-106 need not be located within the same clean room.

### System Module Controller and Programming

The FAB controller 122 may comprise any conventional fabrication controller, fabrication host, or manufacturing execution system (MES) capable of administering process flow among a plurality of processing tools (as is known in the art), but that is configured to communicate with the module controller 120 for receiving information therefrom (as described further below). The FAB controller 122, for example, may monitor wafer lots or lot numbers, work in progress, equipment quality, module quality, perform wafer/lot dispatching and document management, etc., and may be implemented as hardware, software or a combination thereof.

Note that in the embodiment of FIG. 1A, the module controller 110 is illustrated as a “central” controller that may communicate with the subsystems 102-106 (e.g., with the integrated inspection system of each subsystem) to receive feedforward and feedback information, to determine appropriate processes to perform within each subsystem based on the feedforward and/or feedback information, to direct each subsystem to perform a process, etc., as described below. FIG. 1B illustrates an alternative embodiment for the system 100 wherein the module controller 110 (e.g., at least a portion of the functionality of the module controller 110) is “distributed” among the subsystems 102-106. That is, each of the subsystems 102-106 includes an embedded module controller (EMC) 102a-106a, respectively, and an automated process control (APC) module 102b-106b, respectively. In at least one embodiment of the invention, EMC's 102a-106a communicate with the module controller 110 to provide feedforward and/or feedback information to the module controller 110, to receive processes from the module controller 110, etc. The EMC's 102a-106a and the APC modules 102b-106b are described further below.

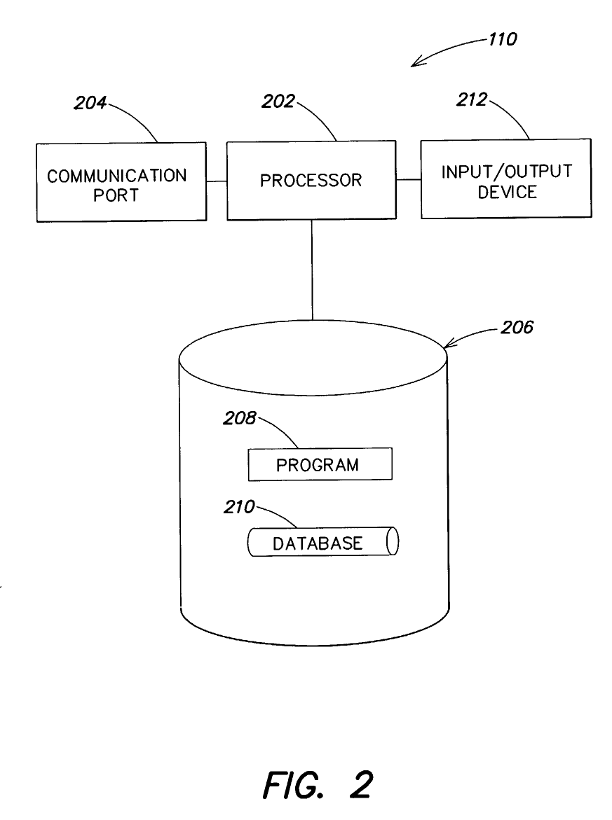

FIG. 2 is a schematic diagram of an exemplary embodiment of the module controller 110 of FIGS. 1A and/or 1B. The module controller 110 may be implemented as a system controller, as a dedicated hardware circuit, as an appropriately programmed general purpose computer, or as any other equivalent electronic, mechanical or electromechanical device.

With reference to FIG. 2 the module controller 110 comprises a processor 202, such as one or more conventional microprocessors (e.g., one or more Intel® Pentium® processors). The processor 202 is in communication with a communication port 204 through which the processor 202 communicates with other devices (e.g., with subsystems 102-106, with the EMC's 102a-106a, with the FAB controller 112 and/or with any other relevant device). The communication port 204 may include multiple communication channels for simultaneous communication with, for example, the barrier/seed layer deposition subsystem 102, the electroplating subsystem 104, the planarization subsystem 106, the EMC's 102a-106a, the FAB controller 112 and/or any other relevant device.

Those skilled in the art will understand that devices in communication with each other need only be capable of communicating with each other and need not be continually transmitting data to or receiving data from each other. On the contrary, such devices need only transmit data to or receive data from each other as necessary, and may actually refrain from exchanging data most the time. Further, devices may be in communication even though steps may be required to establish a communication link.

The processor 202 also is in communication with a data storage device 206. The data storage device 206 may comprise an appropriate combination of magnetic, optical and/or semiconductor memory, and may include, for example, random access memory (RAM), read only memory (ROM), a compact disk, a floppy disk, a DVD, a hard disk, or any other storage medium. The processor 202 and the data storage device 206 each may be, for example, located entirely within a single computer or other computing device, or connected to each other by a communication medium, such as a serial port cable, a telephone line or a radio frequency transceiver. Alternatively, the module controller 110 may comprise one or more computers that are connected to a remote server computer (not shown).

In the exemplary embodiment of the module controller 110 shown in FIG. 2, the data storage device 206 may store, for example, (i) a program 208 (e.g., computer program code and/or a computer program product) adapted to direct the processor 202 in accordance with the present invention, and particularly in accordance with one or more of the processes described in detail below; and (ii) a database 210 adapted to store various information employed by the module controller 110 such as process recipes for one or more of the subsystems 102-106, algorithms for controlling the operation of one or more of the subsystems 102-106 based on feedforward and/or feedback information as described further below, and/or any other relevant information (e.g. system status, processing conditions, process models, substrate history, metrology and/or defect data for each substrate, etc.). Note that rather than employing a database 210 to store process recipes, algorithms or the like, such information may be hard coded in the program 208.

The program 208 may be stored in a compressed, an uncompiled and/or an encrypted format, and may include computer program code that allows the module controller 110 to:

1. determine a barrier layer deposition process to perform on a substrate within the barrier/seed layer deposition subsystem 102 on a substrate (e.g., based on information about the substrate such as interconnect feature density, dimensions and/or profile, based on information about a substrate previously processed within the barrier/seed layer deposition subsystem 102, etc.);

2. direct the barrier/seed layer deposition subsystem 102 to deposit the barrier layer on the substrate based on the barrier layer deposition process;

3. receive information about the deposited barrier layer from an integrated inspection system of the barrier/seed layer deposition subsystem 102;

4. determine a seed layer deposition process to perform on a substrate within the barrier/seed layer deposition subsystem 102 (e.g., based on information about the substrate such as interconnect feature density, dimensions and/or profile, based on information about a substrate previously processed within the barrier/seed layer deposition subsystem 102, etc.);

5. direct the barrier/seed layer deposition subsystem 102 to deposit the seed layer on the substrate based on the seed layer deposition process;

6. receive information about the deposited seed layer from an integrated inspection system of the barrier/seed layer deposition subsystem 102;

7. determine an electroplating process to perform on substrate within the electroplating subsystem 104 (e.g., based on information received from the inspection system of the barrier/seed layer deposition subsystem 102 about the interconnect features of the substrate and/or a barrier layer and/or a seed layer deposited on the substrate, based on information regarding a substrate previously processed within the electroplating subsystem 104, etc.);

8. direct the electroplating subsystem 104 to deposit a fill layer on the substrate based on the electroplating process (e.g., to fill the interconnect features of the substrate);

9. receive information about the fill layer deposited on the substrate from an integrated inspection system of the electroplating subsystem 104;

10. determine a planarization process to perform on a substrate within the planarization subsystem 106 (e.g., based on information received from the inspection system of the electroplating subsystem 104 about the deposited fill layer, based on information obtained regarding a substrate previously processed within the planarization subsystem 106, etc.);

11. direct the planarization subsystem 106 to planarize the substrate based on the planarization process; and/or

12. receive information from an integrated inspection system of the planarization subsystem 106 regarding the substrate.

Numerous additional functions and/or processes may be performed via the module controller 110 as described further below. The module controller 110 may include any peripheral devices (e.g., keyboards, computer displays, pointing devices, etc., represented generally as input/output device 212) required to implement the above functionality.

Note that instructions of the program 208 may be read into a main memory (not shown) of the processor 202 from a computer readable medium other than the data storage device 206 such as from a ROM or from a RAM. While execution of sequences of instructions in the program 208 causes the processor 202 to perform the process steps described herein, hardwired circuitry may be used in place of, or in combination with, software instructions for implementation of the processes of the present invention. Thus, embodiments of the present invention are not limited to any specific combination of hardware and software. The embedded module controllers (EMC's) 102a-106a and/or the automated process control (APC) modules 102b-106b may be configured similarly to the module controller 110.

### Barrier/Seed Layer Deposition Subsystem

FIG. 3 is a top plan view of an exemplary embodiment of the barrier/seed layer deposition subsystem 102 of FIGS. 1A and/or 1B. With reference to FIG. 3, the barrier/seed layer deposition subsystem 102 comprises a processing subsystem 302 coupled to a factory interface 304. The processing subsystem 302 includes a buffer chamber 306a and a transfer chamber 306b which house a first substrate handler 308a and a second substrate handler 308b, respectively. The buffer chamber 306a is coupled to a first loadlock 310a and a second loadlock 310b. The transfer chamber 306b is coupled to the buffer chamber 306a, a pre-clean chamber 311, a barrier layer deposition chamber 312 and a seed layer deposition chamber 314.

The buffer chamber 306a also may be coupled to a first auxiliary processing chamber 316a, a second auxiliary processing chamber 316b and/or a third auxiliary processing chamber 316c. Fewer or more barrier layer deposition chambers, seed layer deposition chambers or auxiliary processing chambers may be employed, and the module controller 110 may communicate with and/or control the processes performed within each chamber.

Loadlock chambers 310a-b may comprise any conventional loadlock chambers capable of transferring substrates from the factory interface 304 to the buffer chamber 306a. The pre-clean chamber 311 may comprise any conventional processing chamber capable of cleaning an interconnect feature (e.g., to remove a metal oxide such as copper oxide from an underlying metal layer to be connected to with the interconnect) such as a conventional high density plasma (HDP) etch chamber.

The barrier layer deposition chamber 312 may comprise any conventional processing chamber capable of depositing a barrier layer on a substrate such as self-ionizing plasma (SIP) physical vapor deposition (PVD) chamber, a high density plasma (HDP) PVD chamber or the like. In at least one embodiment, the barrier layer deposition chamber 312 is a Ta/TaN SIP PVD chamber.

The seed layer deposition chamber 314 may comprise any conventional processing chamber capable of depositing a seed layer on a substrate such as an SIP PVD chamber, a HDP PVD chamber or the like. In at least one embodiment, the seed layer deposition chamber 314 is a copper SIP PVD chamber. The auxiliary processing chambers 316a-c, if employed, may include, for example, cooldown chambers, substrate orienters, degas chambers, inspections chambers or the like.

In at least one embodiment of the invention, the processing subsystem 302 is based on an Endura™ platform manufactured by Applied Materials, Inc. Any other barrier/seed layer deposition system configuration may be similarly employed.

The factory interface 304 includes a buffer chamber 318 which houses a third substrate handler 320 and which is coupled to a plurality of loadports 322a-d. It will understood that in general, any number of substrate handlers may be located within the buffer chamber 318, and that any number of loadports may be coupled to the buffer chamber 318.

### Integrated Inspection for Barrier/Seed Layer Deposition Subsystem

As shown in FIG. 3, the barrier/seed layer deposition subsystem 102 includes an integrated inspection system 324. In the exemplary embodiment of FIG. 3, the integrated inspection system 324 includes a defect detection subsystem 324a and a metrology subsystem 324b both coupled to the buffer chamber 318 of the factory interface 304. Alternatively, the integrated inspection system 324 may include only one of the defect detection subsystem 324a and the metrology subsystem 324b, or may be coupled to the processing subsystem 302 rather than to the factory interface 304 (e.g., by coupling the defect detection subsystem 324a and/or the metrology subsystem 324b to the buffer chamber 306a such as at the location of one or more of the auxiliary processing chambers 316a-c).

### Defect Detection for Barrier/Seed Layer Deposition Subsystem

The defect detection subsystem 324a may comprise any conventional defect detection subsystem capable of detecting, characterizing and/or classifying defects on a surface of a substrate. In at least one embodiment of the invention, the defect detection subsystem 324a comprises the Excite™ or integrated particle monitor (IPM™) defect detection subsystem manufactured by Applied Materials, Inc. and described in U.S. patent application Ser. No. 09/110,870, filed Jul. 7, 1998 and titled “A PIXEL BASED MACHINE FOR PATTERNED WAFERS”, which is hereby incorporated by reference herein in its entirety. The defect detection subsystem 324a may, for example, merely provide a measure of defect density on a substrate surface or may provide detailed information about any detected defects such as defect characterization or classification information. The defect detection subsystem 324a may provide such information to the module controller 110 (and/or to the embedded module controller (EMC) 102a in the system of FIG. 1B).

### Metrology for Barrier/Seed Layer Deposition Subsystem

The metrology subsystem 324b may comprise any conventional metrology subsystem capable of measuring barrier layer and/or seed layer thickness or other relevant barrier and/or seed layer information. Exemplary metrology subsystems include x-ray, thermal, sonic, laser, optical interference, light scattering or eddy-current based metrology subsystems, four point probes, etc. The metrology subsystem 324b also may measure the dimensions of interconnect features present on a substrate (e.g., line or via depth, width, profile, and/or other critical dimension information). In at least one embodiment of the invention, the metrology subsystem 324b comprises an x-ray reflectometry system that examines the x-ray interference pattern produced by a film to determine film thickness, density, roughness, etc. One such system is the METAPROBEX reflectometer manufactured by Thermawave, Inc., although other systems may be employed. For determining interconnect feature information, the metrology system 324b may include a laser based metrology subsystem wherein laser light is scattered off of a substrate surface and analyzed to determine interconnect feature density, depth, profile, width and/or other critical dimension information as is known in the art.

The metrology subsystem 324b can provide information regarding interconnect feature density and/or dimensions/profile to the module controller 110, and based on this information the module controller 110 may determine an appropriate barrier layer and/or seed layer process for a substrate as described further below. In the embodiment of FIG. 1B, the embedded module controller (EMC) 102a additionally or alternatively may perform such functions.

### Operation of Barrier/Seed Layer Deposition Subsystem

In operation, a cassette or “carrier” of substrates is delivered to the factory interface 304 of the barrier/seed layer deposition subsystem 102. In particular, the substrate carrier is delivered to one of the loadports 322a-d. Each loadport 322a-d may or may not be configured with pod opening capability for opening sealed substrate carriers. Once the substrate carrier has been loaded into the appropriate loadport 322a-d of the factory interface 304, the substrate handler 320 retrieves a substrate from the substrate carrier and transfers the substrate to the first loadlock 310a. Thereafter the substrate handler 308a of the processing subsystem 302 retrieves the substrate from the first loadlock 310a and transfers the substrate to a degas chamber (e.g., one of the auxiliary chambers 316a-c) where the substrate is degassed. After the substrate is degassed, the substrate handler 308a transfers the substrate to a first pass-through 326 of the processing subsystem 302.

The substrate handler 308b of the processing subsystem 302 retrieves the substrate from the first pass-through 326 and transfers the substrate to the preclean chamber 311 where the substrate is precleaned (e.g., to remove metal oxide from a base of each interconnect feature formed on the substrate) as is known in the art. The substrate then is transferred to the barrier layer deposition chamber 312.

Within the barrier layer deposition chamber 312, a barrier layer is deposited on the substrate (e.g., in accordance with one or more of the inventive processes described below) and the substrate is transferred to the seed layer deposition chamber 314. Within the seed layer deposition chamber 314, a seed layer is deposited on the substrate.

Thereafter, the substrate is transferred to a second pass-through 328 of the processing subsystem 302 by the substrate handler 308b and the substrate handler 308a then transfers the substrate to the loadlock 310b. After barrier layer and/or seed layer deposition, the substrate may be processed within one or more of the auxiliary processing chambers 316a-c (e.g., for substrate orientation purposes, for degassing, for cooldown, etc.).

After the substrate has been returned to the second loadlock 310b, the substrate handler 320 of the factory interface 304 retrieves the substrate from the second loadlock 310b and transfers the substrate to one of the defect detection subsystem 324a and the metrology subsystem 324b. Assuming the substrate is first transferred to the defect detection subsystem 324a, the defect detection subsystem 324a performs defect detection on the substrate (e.g., determines the defect density on the surface of the substrate, identifies or otherwise characterizes or classifies defects on the surface of the substrate, etc.) and communicates information regarding the results of the defect detection to the module controller 110 (and/or to the embedded module controller (EMC) 102a in the system of FIG. 1B). Following defect detection, the substrate handler 320 of the factory interface 304 retrieves the substrate from the defect detection subsystem 324a and transfers the substrate to the metrology subsystem 324b.

The metrology subsystem 324b analyzes the substrate to determine such information as barrier layer thickness, seed layer thickness, and/or other critical dimension information. The metrology subsystem 324b then provides this information to the module controller 110 (and/or to the embedded module controller (EMC) 102a in the system of FIG. 1B). Thereafter, the substrate handler 320 of the factory interface 304 retrieves the substrate from the metrology subsystem 324b and returns the substrate to a substrate carrier (located within one of the loadports 322a-d).

It will be understood that more than one substrate may be processed at a time within the barrier/seed layer deposition subsystem 102. For example, while one substrate is being processed within the barrier layer deposition chamber 312, up to two other substrates may be simultaneously processed within the chambers 311 and 314. Likewise, substrates may be processed within the chambers 311-314 while defect detection is performed within the defect detection subsystem 324a or while metrology is performed within the metrology subsystem 324b on a different substrate. In this manner, because of the integrated nature of the defect detection subsystem 324a and the metrology subsystem 324b, defect detection measurements and/or metrology measurements have little affect on the throughput of the barrier/seed layer deposition subsystem 102. Defect detection and/or metrology therefore may be performed on every substrate processed within the barrier/seed layer deposition subsystem 102 (if desired).

Either the module controller 110 or the FAB controller 112 may comprise computer program code for performing the various substrate transfer operations described above. The embedded module controller (EMC) 102a also may comprise such computer program code.

Note that while the operation of the barrier/seed layer deposition subsystem 102 has been described with regard to performing defect detection and/or metrology on a deposited barrier layer and a deposited seed layer only after both layers have been deposited, the defect detection subsystem 324a and the metrology subsystem 324b may perform defect detection and metrology, respectively, on a deposited barrier layer before a seed layer is formed over the barrier layer.

The metrology subsystem 324a also may be employed to measure the dimensions of interconnect features of a substrate (e.g., via and/or line width, depth, profile, etc.) prior to barrier layer deposition, and to communicate such dimension information to the module controller 110 and/or to the embedded module controller (EMC) 102a. This information then may be used to determine a barrier layer deposition process and/or a seed layer deposition process to perform within the barrier layer deposition chamber 312 and/or the seed layer deposition chamber 314, respectively, as described further below. Interconnect feature density may be similarly determined and employed.

In an embodiment wherein the subsystem 102 employs the embedded module controller (EMC) 102a and the automated process control (APC) module 102b (FIG. 1B), all or part of the information obtained from the integrated inspection system 324 may be communicated to the embedded module controller (EMC) 102a of the subsystem 102. In this manner, the embedded module controller (EMC) 102a and the automated process control (APC) module 102b may at least partially control the processes performed within the chambers 312, 314 based on information from the integrated inspection system 324 (as described below).

### Electroplating Subsystem

FIG. 4 is a top plan view of an exemplary embodiment of the electroplating subsystem 104 of the inventive system 100 of FIGS. 1A and 1B. With reference to FIG. 4, the electroplating subsystem 104 comprises a processing subsystem 402 coupled to a factory interface 404. The processing subsystem 402 includes a chamber 406 which houses a first substrate handler 408. The first substrate handler 408 has two individually controllable robot arms 410a, 410b. The chamber 406 also includes a first electroplating chamber 412a, a second electroplating chamber 412b, a third electroplating chamber 412c, and a fourth electroplating chamber 412d. The chamber 406 further includes an integrated bevel cleaner 414 and a spin rinse dryer 416 (in a stacked configuration, although other configurations may be employed).

The electroplating chambers 412a-d may comprise any conventional electroplating chambers capable of depositing a fill layer on the substrate (e.g., a metal layer such as copper or aluminum that “fills” interconnect features such as vias or lines etched within an interlayer dielectric). In at least one embodiment, each electroplating chamber 412a-d is capable of depositing a copper fill layer on a substrate via the interaction of a copper sulfide base solution with a sulfuric acid (H₂SO₄) solution as is known in the art.

The integrated bevel cleaner 414 may comprise any conventional tool for removing deposited layers from an edge of a substrate. In at least one embodiment, the integrated bevel cleaner 414 directs an etchant solution (e.g., H₂SO₄ and hydrogen peroxide) toward a beveled edge of a substrate to remove metal layers therefrom. The use of an etchant solution for substrate edge cleaning is well known and is not described further herein. The spin rinse dryer 416 may comprise any conventional spin rinse dryer capable of cleaning, rinsing and/or drying a substrate following edge cleaning.

It will be understood that the processing subsystem 402 may be based on any equipment platform. For example, the processing subsystem 402 may be an Electra™ integrated electrochemical process (IECP™) system manufactured by Applied Materials, Inc. Suitable electroplating chambers/systems are also described in U.S. Pat. Nos. 6,113,771 and 6,258,220 which are hereby incorporated by reference herein in their entirety. Other systems/platforms may be employed.

The factory interface 404 includes a buffer chamber 418 which houses a second substrate handler 420, a third substrate handler 422 and an orienter 424, and which is coupled to a plurality of loadports 426a-b. It will understood that in general, any number of substrate handlers may be located within the buffer chamber 418, and that any number of loadports may be coupled to the buffer chamber 418. A first anneal chamber 427a and a second anneal chamber 427b also are coupled to the buffer chamber 418.

### Integrated Inspection for Electroplating Subsystem

As shown in FIG. 4, the electroplating subsystem 104 includes a first integrated inspection system 428 and a second integrated inspection system 430. In the exemplary embodiment of FIG. 4, the first integrated inspection system 428 includes a defect detection subsystem 428a and a metrology subsystem 428b both coupled to the first anneal chamber 427a. The second integrated inspection system 430 includes a defect detection subsystem 430a and a metrology subsystem 430b both coupled to the second anneal chamber 427b. Alternatively, each integrated inspection system may include only one of a defect detection subsystem and a metrology subsystem, or may be coupled to the processing subsystem 402 rather than to the factory interface 404.

### Defect Detection for Electroplating Subsystem

Each defect detection subsystem 428a, 430a may comprise any conventional defect detection subsystem capable of detecting, characterizing and/or classifying defects on a surface of a substrate. In at least one embodiment of the invention, each defect detection subsystem 428a, 430a comprises the Excite™ or IPM™ defect detection subsystem manufactured by Applied Materials, Inc. and described in previously incorporated U.S. patent application Ser. No. 09/110,870, filed Jul. 7, 1998. Each defect detection subsystem 428, 430a may, for example, merely provide a measure of defect density on a substrate surface or may provide detailed information about any detected defects such as defect characterization or classification information. Each defect detection subsystem 428a, 430 may provide such information to the module controller 110 (and/or to the embedded module controller (EMC) 104a in the system of FIG. 1B).

### Metrology for Electroplating Subsystem

The metrology subsystems 428b, 430b may comprise any conventional metrology subsystems capable of measuring the thickness of a deposited fill layer (e.g., an electroplated metal layer) such as x-ray, thermal, sonic, laser, optical interference, light scattering or eddy-current based metrology subsystems, four point probes, etc. In at least one embodiment of the invention, each metrology subsystem 428b, 430b comprises an x-ray reflectometry system that examines the x-ray interference pattern produced by a film to determine film thickness, density, roughness, etc. One such system is the METAPROBEX reflectometer manufactured by Thermawave, Inc., although other systems may be employed. The defect detection subsystems 428a, 430a and/or the metrology subsystems 428b, 430b may share chambers with the anneal chambers 427a, 427b or may use separate chambers.

### Operation of Electroplating Subsystem

In operation, a substrate carrier is delivered to the factory interface 404 of the electroplating subsystem 104. In particular, the substrate carrier is delivered to one of the loadports 426a-b. Each loadport 426a-b may or may not be configured with pod opening capability for opening sealed substrate carriers. Once the substrate carrier has been loaded into the appropriate loadport 426a-b, one of the substrate handlers 420, 422 retrieves a substrate from the substrate carrier and transfers the substrate to the orienter 424. The orienter 424 orients the substrate (e.g., by locating a flat or notch on the substrate as is known in the art).

Thereafter the substrate handler 408 of the processing subsystem 402 retrieves the substrate from the orienter 424 and transfers the substrate to one of the electroplating chambers 412a-d. A metal fill layer then is deposited on the substrate (e.g., in accordance with one or more of the inventive processes described below) and the substrate is transferred to the integrated bevel cleaner 414 (by one of the robot arms 410a, 410b of the substrate handler 408).

Once the substrate has been transferred to the integrated bevel cleaner 414, the integrated bevel cleaner 414 cleans the edge (bevel) of the substrate (e.g., via an etchant). Following edge cleaning, the substrate is transferred to the spin rinse dryer 416 wherein the substrate is (1) cleaned (e.g., to remove residue from the edge cleaning process); (2) rinsed; and/or (3) dried.

Following the spin-rinse-dry process, the substrate is transferred to one of the anneal chambers 427a, 417b of the factory interface 404 (e.g., via one of the substrate handlers 420, 422). Assuming the substrate is transferred to the first anneal chamber 427a, the substrate is annealed within the first anneal chamber 427a. In at least one embodiment, the substrate is annealed in forming gas, nitrogen or argon at 250° C. for about 30 seconds, and the substrate then is rapidly cooled (e.g., within about 30 seconds). Such annealing stabilizes copper grain structure and copper resistivity. Other annealing processes also may be employed such as laser annealing, pedestal annealing, high pressure annealing or the like.

Following annealing, defection detection and/or metrology are performed on the substrate (e.g., via the defect detection subsystem 428a and the metrology subsystem 428b), in any order. For example, the defect detection subsystem 428a may perform defect detection on the substrate (e.g., to determine the defect density of the surface of the electroplated fill layer, to identify or otherwise characterize or classify defects on the surface of the electroplated fill layer, etc.) and may communicate information regarding the results of the defect detection to the module controller 110 (and/or to the embedded module controller (EMC) 104a in the system of FIG. 1B).

The metrology subsystem 428b may analyze the substrate to determine such information as electroplated fill layer thickness and may provide this information to the module controller 110 (and/or to the embedded module controller (EMC) 104a in the system of FIG. 1B). The substrate handler 420 then retrieves the substrate from the anneal chamber 427a and returns the substrate to a substrate carrier (located within one of the loadports 426a-b).

It will be understood that more than one substrate may be processed at a time within the electroplating subsystem 104. For example, while one substrate is being processed within the electroplating chamber 412a, up to three other substrates may be simultaneously processed within the electroplating chambers 412b-d. Likewise, substrates may be processed within the chambers 412a-d while defect detection is performed by the defect detection subsystems 428a, 430a, while metrology is performed by the metrology subsystems 428b, 430b, or while anneal processes are performed on different substrates (within the anneal chambers 427a, 427b). In this manner, because of the integrated nature of the defect detection subsystems 428a, 430a and the metrology subsystems 428b, 430b, defect detection measurements and/or metrology measurements have little affect on the throughput of the electroplating subsystem 104. Defect detection and/or metrology therefore may be performed on every substrate processed within the electroplating subsystem 104 (if desired).

Either the module controller 110 or the FAB controller 112 may comprise computer program code for performing the various substrate transfer operations described above. The embedded module controller (EMC) 104a also may comprise such computer program code.

### Planarization Subsystem

FIG. 5A is a top plan view of a first exemplary embodiment of the planarization subsystem 106 of FIGS. 1A and 1B. In general, the planarization subsystem 106 may comprise any tool or apparatus capable of planarizing a substrate as is known in the art and configured in accordance with the present invention as described below.

With reference to FIG. 5A, the planarization subsystem 106 includes a processing subsystem 502 coupled to a factory interface 504. In the exemplary embodiment of FIG. 5A, the processing subsystem 502 comprises a Mirra Mesa™ planarization system manufactured by Applied Materials, Inc. (e.g., a 200 mm substrate planarization tool) and described in U.S. patent application Ser. No. 09/547,189, filed Apr. 11, 2000 and titled “METHOD AND APPARATUS FOR TRANSFERRING SEMICONDUCTOR SUBSTRATES USING AN INPUT MODULE”, which is hereby incorporated by reference herein in its entirety. It will be understood that any other planarization apparatus may be similarly employed.

The processing subsystem 502 includes a robot 506 that is movable along a track 508, an input shuttle 510, a polishing system 512 and a cleaning system 514. The polishing system 512 includes a load cup 516, a first polishing platen 518a (e.g., a bulk polishing platen), a second polishing platen 518b (e.g., an endpoint on barrier layer polishing platen) and a third polishing platen 518c (e.g., a barrier layer buff polishing platen). The cleaning system 514 includes an input module 520a, a megasonic module 520b, a first scrubber module 520c, a second scrubber module 520d, a spin rinse dryer module 520e and an output module 520f.

Factory interface 504 includes a buffer chamber 522, a substrate handler 524 located within the buffer chamber 522 and a plurality of loadports 526a-d coupled to the buffer chamber 522. An integrated inspection system 528 also is coupled to the buffer chamber 522 as shown. In general, any number of substrate handlers and/or loadports may be employed within the factory interface 504.

### Integrated Inspection for Planarization Subystem

In the exemplary embodiment of FIG. 5A, the integrated inspection system 528 includes a defect detection subsystem 530a and a metrology subsystem 530b both coupled to the buffer chamber 522 of the factory interface 504. Alternatively, the integrated inspection system 528 may include only one of the defect detection subsystem 530a and the metrology subsystem 530b.

### Defect Detection for Planarization Subsystem

The defect detection subsystem 530a may comprise any conventional defect detection subsystem capable of detecting, characterizing and/or classifying defects on a surface of a substrate. In at least one embodiment of the invention, the defect detection subsystem 530a comprises the Excite™ or IPM™ defect detection subsystem manufactured by Applied Materials, Inc. and described in previously incorporated U.S. patent application Ser. No. 09/110,870, filed Jul. 7, 1998. The defect detection subsystem 530a may, for example, merely provide a measure of defect density on a substrate surface or may provide detailed information about any detected defects such as defect characterization or classification information. The defect detection subsystem 530a may provide such information to the module controller 110 (and/or to the embedded module controller (EMC) 106a in the system of FIG. 1B.)

### Metrology for Planarization Subsystem

The metrology subsystem 530b may comprise any conventional metrology subsystem capable of measuring, for example, the planarity of a planarized substrate or any other relevant parameter such as dishing within interconnect features, fill layer residue, surface erosion and the like. In at least one embodiment of the invention, the metrology subsystem 530b may comprise a reflectometry-based thickness measurement tool such as a NanoSpec 9000 or 9000B measurement tool manufactured by Nanometrics or a Novascan 840, 2020, 2200, 3000 or 3030 measurement tool manufactured by Nova Measuring Instruments; or an eddy-current based thickness measurement tool such as described in U.S. patent application Ser. Nos. 09/574,008, filed May 19, 2000 and titled “EDDY CURRENT SENSING OF METAL REMOVAL FOR CHEMICAL MECHANICAL POLISHING”; 09/900,664, filed Jul. 6, 2001 and titled “COMBINED EDDY CURRENT SENSING AND OPTICAL MONITORING FOR CHEMICAL MECHANICAL POLISHING”; and 09/918,591, filed Jul. 27, 2001 and titled “CHEMICAL MECHANICAL POLISHING OF A METAL LAYER WITH POLISHING RATE MONITORING”, all of which are hereby incorporated by reference herein in their entirety.

### Operation of Planarization Subsystem

In operation, a substrate carrier is delivered to the factory interface 504 of the planarization subsystem 106. In particular, the substrate carrier is delivered to one of the loadports 526a-d. Each loadport 526a-d may or may not be configured with pod opening capability for opening sealed substrate carriers. Once the substrate carrier has been loaded into the appropriate loadport 526a-d, the substrate handler 524 retrieves a substrate from the substrate carrier and transfers the substrate to the robot 506. Thereafter the robot 506 transfers the substrate to the load cup 516 of the polishing system 512 via the track 508. The substrate is then polished within the polishing system 512 (e.g., in accordance with one or more of the inventive processes described below employing one or more of the polishing platens 518a-c) and is transferred to the input module 520a of the cleaning system 514 via the input shuttle 510.

The substrate is cleaned in the megasonic module 520b, scrubbed within one or both of the scrubber modules 520c-d and dried in the spin rinse dryer module 520e. The substrate then is transferred to the output module 520f and from the output module 520f to the substrate handler 524 (via the robot 506).

The substrate handler 524 transfers the substrate to one of the defect detection subsystem 530a and the metrology subsystem 530b. Assuming the substrate is first transferred to the defect detection subsystem 530a, the defect detection subsystem 530a performs defect detection (e.g., determines the defect density on the surface of the substrate, identifies or otherwise characterizes or classifies defects on the surface of the substrate, etc.) and communicates information regarding the results of the defect detection to the module controller 110 (and/or to the embedded module controller (EMC) 106a in the system of FIG. 1B). The substrate handler 524 retrieves the substrate from the defect detection subsystem 530a and transfers the substrate to the metrology subsystem 530b.

The metrology subsystem 530b analyzes the substrate to determine such information as surface planarity and provides this information to the module controller 110 (and/or to the EMC 106a in the system of FIG. 1B). The substrate handler 524 retrieves the substrate from the metrology subsystem 530b and returns the substrate to a substrate carrier (located within one of the loadports 526a-d).

It will be understood that more than one substrate may be processed at a time within the planarization subsystem 106. For example, while one substrate is being processed within the polishing system 512 (e.g., on one platen), other substrates may be simultaneously processed within the polishing system 512 (e.g., on other platens) and/or cleaned within the cleaning system 514. Likewise, substrates may be processed within the polishing system 512 and/or the cleaning system 514 while defect detection is performed within the defect detection subsystem 530a or while metrology is performed within the metrology subsystem 530b on a different substrate. In this manner, because of the integrated nature of the defect detection subsystem 530a and the metrology subsystem 530b, defect detection measurements and/or metrology measurements have little effect on the throughput of the planarization subsystem 106. Defect detection and/or metrology therefore may be performed on every substrate processed within the planarization subsystem 106 (if desired).

Either the module controller 110 or the FAB controller 112 may comprise computer program code for performing the various substrate transfer operations described above. The embedded module controller (EMC) 106a also may comprise such computer program code.

### Alternative Planarization Subsystem

FIG. 5B is a top plan view of a second exemplary embodiment of the planarization subsystem 106 of FIGS. 1A and 1B (referred to as planarization subsystem 106′ for convenience). The planarization subsystem 106′ of FIG. 5B is similar to the planarization subsystem 106 of FIG. 5A, and includes a processing subsystem 502′ coupled to a factory interface 504′. In the exemplary embodiment of FIG. 5B, the processing subsystem 502′ comprises a Reflexion™ planarization system manufactured by Applied Materials, Inc. (e.g., a 300 mm substrate planarization tool) and described in U.S. patent application Ser. No. 09/244,456, filed Feb. 4, 1999 and titled “APPARATUS AND METHODS FOR CHEMICAL MECHANICAL POLISHING WITH AN ADVANCEABLE POLISHING SHEET”, which is hereby incorporated by reference herein in its entirety.

The processing subsystem 502′ includes a substrate handler 506′ (e.g., a “wet” robot), an input shuttle 510′, a polishing system 512′ and a cleaning system 514′. The polishing system 512′ includes a load cup 516′, a first polishing platen 518a′ (e.g., a bulk polishing platen), a second polishing platen 518b′ (e.g., an endpoint on barrier layer polishing platen) and a third polishing platen 518c′ (e.g., a barrier layer buff polishing platen). The cleaning system 514′ includes an input module 520a′, a megasonic module 520b′, a first scrubber module 520c′, a second scrubber module 520d′, a spin rinse dryer module 520e′ and an output module 520f′.

Factory interface 504′ includes a buffer chamber 522′, a substrate handler 524′ located within the buffer chamber 522′ and a plurality of loadports 526a′-b′ coupled to the buffer chamber 522′. An integrated inspection system 528′ also is coupled to the buffer chamber 522′ as shown. In general, any number of substrate handlers and/or loadports may be employed within the factory interface 504′.

### Integrated Inspection for Alternative Planarization Subsystem

In the exemplary embodiment of FIG. 5B, the integrated inspection system 528′ includes a defect detection subsystem 530a′ and a metrology subsystem 530b′ both coupled to the buffer chamber 522′ of the factory interface 504′. Alternatively, the integrated inspection system 528′ may include only one of the defect detection subsystem 530a′ and the metrology subsystem 530b′.

### Defect Detection for Alternative Planarization Subsystem

The defect detection subsystem 530a′ may comprise any conventional defect detection subsystem capable of detecting, characterizing and/or classifying defects on a surface of a substrate. In at least one embodiment of the invention, the defect detection subsystem 530a′ comprises the Excite™ or IPM™ defect detection subsystem manufactured by Applied Materials, Inc. and described in previously incorporated U.S. patent application Ser. No. 09/110,870, filed Jul. 7, 1998. The defect detection subsystem 530a′ may, for example, merely provide a measure of defect density on a substrate surface or may provide detailed information about any detected defects such as defect characterization or classification information. The defect detection subsystem 530a′ may provide such information to the module controller 110 (and/or to the embedded module controller (EMC) 106a in the system of FIG. 1B).

### Metrology for Alternative Planarization Subsystem

The metrology subsystem 530b′ may comprise any conventional metrology subsystem capable of measuring, for example, the planarity of a planarized substrate or any other relevant parameter such as dishing within interconnect features, fill layer residue, surface erosion and the like. In at least one embodiment of the invention, the metrology subsystem 530b′ may comprise a reflectometry-based thickness measurement tool such as a NanoSpec 9000 or 9000B measurement tool manufactured by Nanometrics or a Novascan 840, 2020, 2200, 3000 or 3030 measurement tool manufactured by Nova Measuring Instruments; or an eddy-current based thickness measurement tool such as described in previously incorporated U.S. patent application Ser. Nos. 09/574,008, filed May 19, 2000 and titled “EDDY CURRENT SENSING OF METAL REMOVAL FOR CHEMICAL MECHANICAL POLISHING”; 09/900,664, filed Jul. 6, 2001 and titled “COMBINED EDDY CURRENT SENSING AND OPTICAL MONITORING FOR CHEMICAL MECHANICAL POLISHING”; and 09/918,591, filed Jul. 27, 2001 and titled “CHEMICAL MECHANICAL POLISHING OF A METAL LAYER WITH POLISHING RATE MONITORING”.

### Operation of Alternative Planarization Subsystem

In operation, a substrate carrier is delivered to the factory interface 504′ of the planarization subsystem 106′. In particular, the substrate carrier is delivered to one of the loadports 526a′-b′. Once the substrate carrier has been loaded into the appropriate loadport 526a′-b′, the substrate handler 524′ retrieves a substrate from the substrate carrier and transfers the substrate to the input shuttle 510′. Thereafter the substrate handler 506′ transfers the substrate from the input shuttle 510′ to the load cup 516′ of the polishing system 512′. The substrate is then polished within the polishing system 512′ (e.g., in accordance with one or more of the inventive processes described below employing one or more of the polishing platens 518a′-c′) and is transferred to the input module 520a′ of the cleaning system 514′ via the substrate handler 506′ and the input shuttle 510′.

The substrate is cleaned in the megasonic module 520b′, scrubbed within one or both of the scrubber modules 520c′-d′ and dried in the spin rinse dryer module 520e′. The substrate then is transferred to the output module 520f′ and from the output module 520f′ to the substrate handler 524′ (via the robot 506).

The substrate handler 524′ transfers the substrate to one of the defect detection subsystem 530a′ and the metrology subsystem 530b′. Assuming the substrate is first transferred to the defect detection subsystem 530a′, the defect detection subsystem 530a′ performs defect detection (e.g., determines the defect density on the surface of the substrate, identifies or otherwise characterizes/classifies defects on the surface of the substrate, etc.) and communicates information regarding the results of the defect detection to the module controller 110 (and/or to the EMC 106a in the system of FIG. 1B). The substrate handler 524′ retrieves the substrate from the defect detection subsystem 530a′ and transfers the substrate to the metrology subsystem 530b′.

The metrology subsystem 530b′ analyzes the substrate to determine such information as surface planarity and provides this information to the module controller 110 (and/or to the EMC 106a in the system of FIG. 1B). The substrate handler 524′ retrieves the substrate from the metrology subsystem 530b′ and returns the substrate to a substrate carrier (located within one of the loadports 526a′-b′).

As with the planarization subsystem 106 of FIG. 5A, more than one substrate may be processed at a time within the planarization subsystem 106′. For example, while one substrate is being processed within the polishing system 512′ (e.g., on one platen), other substrates may be simultaneously processed within the polishing system 512′ (e.g., on other platens) and/or cleaned within the cleaning system 514′. Likewise, substrates may be processed within the polishing system 512′ and/or the cleaning system 514′ while defect detection is performed within the defect detection subsystem 530a′ or while metrology is performed within the metrology subsystem 530b′ on a different substrate. In this manner, because of the integrated nature of the defect detection subsystem 530a′ and the metrology subsystem 530b′, defect detection measurements and/or metrology measurements have little affect on the throughput of the planarization subsystem 106′; and defect detection and/or metrology may be performed on every substrate processed within the planarization subsystem 106′ (if desired).

Either the module controller 110 or the FAB controller 112 may comprise computer program code for performing the various substrate transfer operations described above. The embedded module controller (EMC) 106a also may comprise such program code.

### Exemplary Integrated Process and Operation of Integrated System and Method for Forming Interconnects

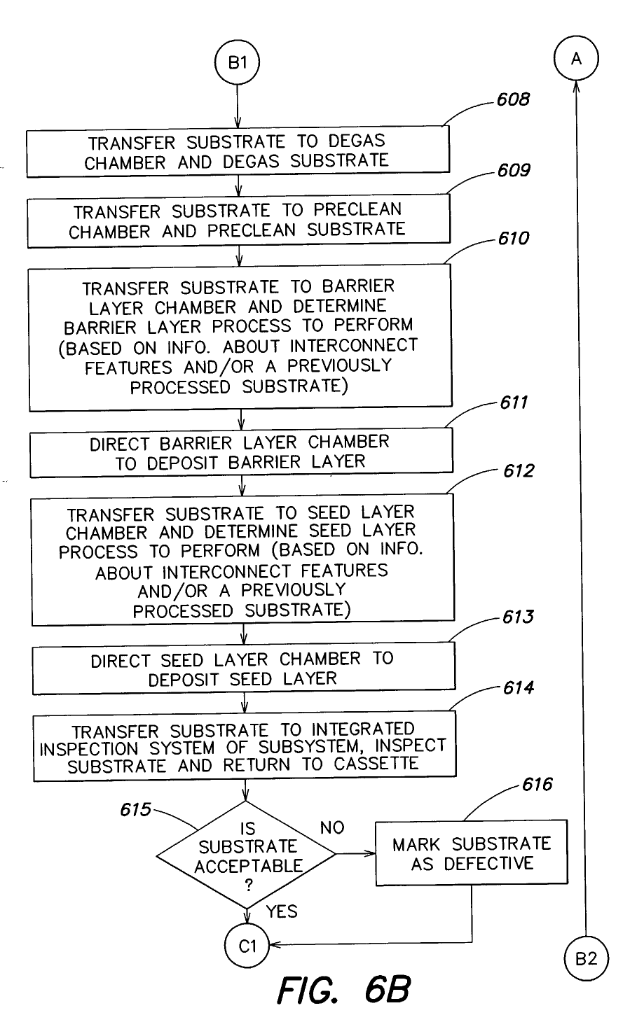

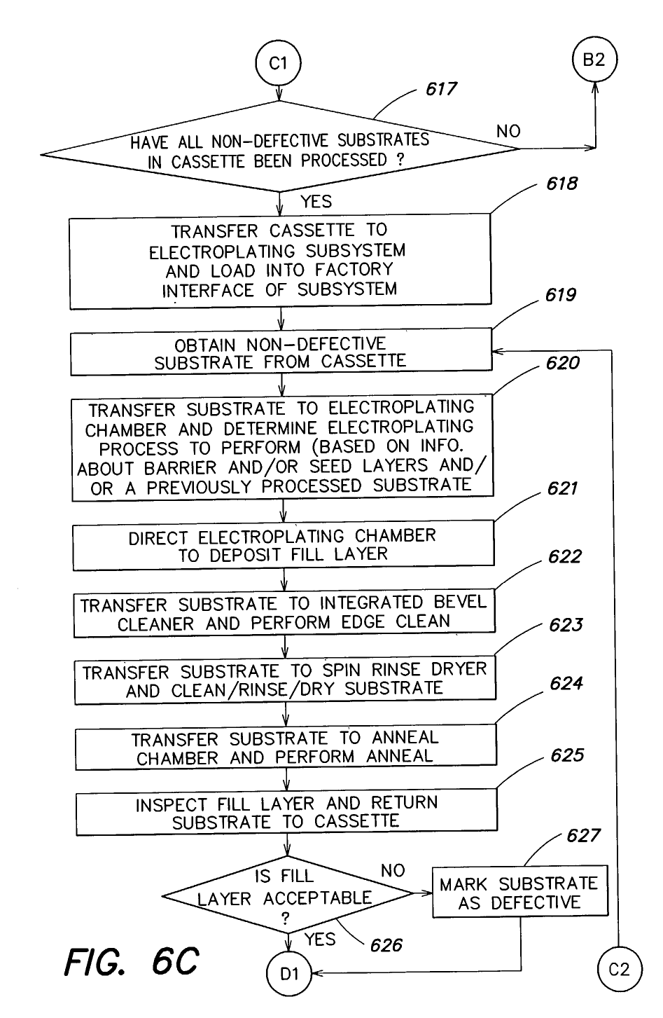

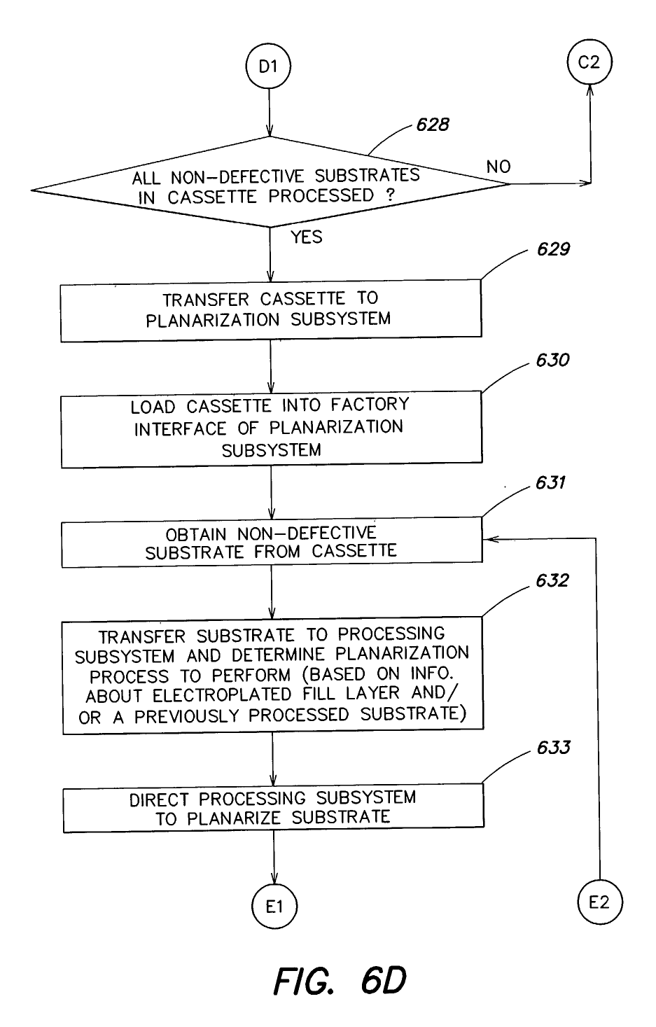

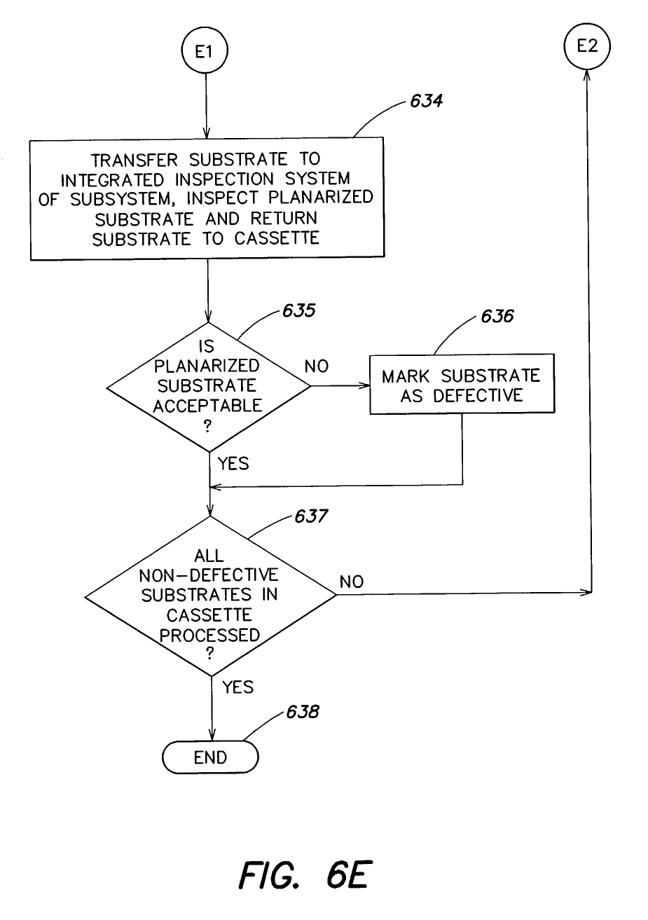

FIGS. 6A-E illustrate a flowchart of an exemplary process 600 for forming interconnects on a substrate in accordance with the present invention. The exemplary process 600 will be described with reference to FIGS. 1A-5B, and FIGS. 7A-E which illustrate cross sectional views of a semiconductor substrate during the process 600 of FIGS. 6A-E. For convenience purposes only, the process 600 is described with reference to the module controller 110 (without use of the embedded module controllers (EMC's) 102a-106a and the automated process control (APC) modules 102b-106b). It will be understood that all or a portion of the process 600 may be similarly performed using one or more of the EMC's 102a-106a and the APC modules 102b-106b alone or in combination with the module controller 110.

With reference to FIGS. 6A-E, the first process 600 begins with step 601. In step 602 the inventive system 100 receives a substrate cassette from an etch tool (not shown) such as the eMax or IPS etch tool manufactured by Applied Materials, Inc. (although any suitable etch tool may be employed). The etch tool may be located within the clean room 108 or in another clean room (not shown) in which case the substrate cassette may be delivered to the clean room 108 via a delivery mechanism (e.g., an overhead conveyor system, an automated guided vehicle, etc.). In step 603, the substrate cassette is loaded into the factory interface 304 of the barrier/seed layer deposition subsystem 102. For example, the substrate cassette may be loaded into one of the loadports 322a-d of the factory interface 304.

In step 604, a substrate is extracted from the substrate cassette and in step 605, interconnect features (e.g., vias and/or lines) formed on the substrate by the etch tool (not shown) and used to define the regions on the substrate where interconnects are to be formed, are inspected via the integrated inspection system 324. Assuming the barrier/seed layer deposition subsystem 102 of FIG. 3 is employed within the system 100, steps 604 and 605 may be performed by employing the substrate handler 320 to extract a substrate from the substrate cassette (located within one of the loadports 322a-d), and by transferring the substrate to the metrology subsystem 324b via the substrate handler 318. Thereafter the metrology subsystem 324b may inspect the substrate's interconnect features and may communicate information about the interconnect features to the module controller 110. For example, the metrology subsystem 324b may communicate information such as interconnect feature density, interconnect feature dimensions (e.g., via and/or line width, depth, profile, etc.) or the like to the module controller 110.

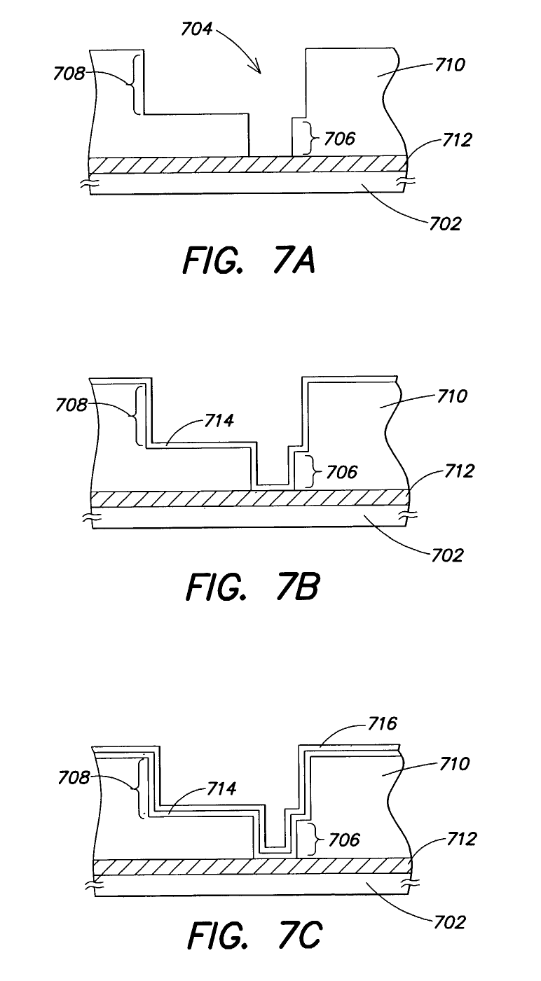

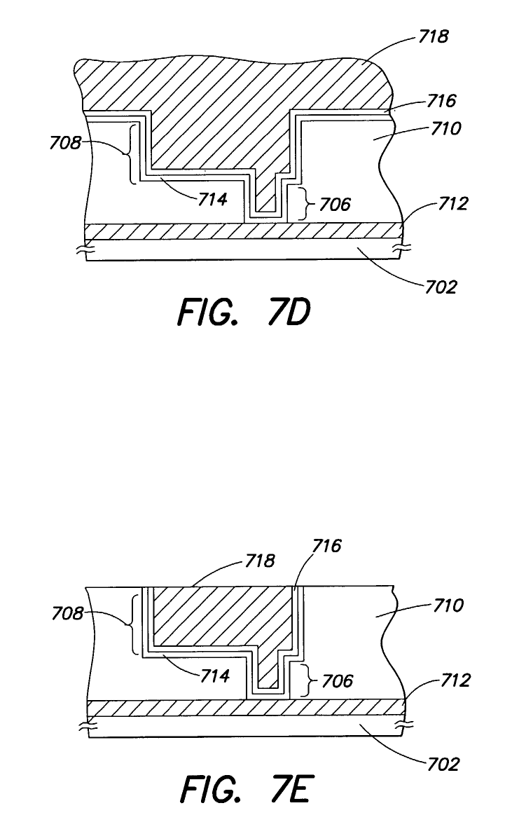

FIG. 7A illustrates an exemplary silicon substrate 702 having an interconnect feature 704 formed thereon. The interconnect feature 704 is a “dual damascene” feature having both a via 706 and a line 708. Any other interconnect feature may be employed (e.g., a “single” damascene feature having only the via 706).

To form the structure of FIG. 7A, an interlayer dielectric 710 is deposited (e.g., via chemical vapor deposition) on a metal layer 712 formed on the silicon substrate 702. The interlayer dielectric 710 may comprise, for example, silicon dioxide having a thickness of about 1,000-20,000 angstroms, or another suitable material such as a low k dielectric material (e.g., a material having a dielectric constant k=1-5, such as fluorinated silicon glass or oxide (FSG), carbon doped oxide (e.g., SiOC), polymer spin on (e.g., a spin on glass), etc.) having a thickness of about 1,000-20,000 angstroms. Thereafter a photoresist layer (not shown) is formed over the interlayer 30 dielectric 710 and is patterned by conventional photolithography techniques. In particular, the photoresist layer (not shown) is exposed and developed so that portions of the underlying interlayer dielectric 710 are exposed and may be etched to form the interconnect feature 704 (and other similar features across the entire surface of substrate 702). The substrate 702 then is etched to form the via 706 and the line 708 using conventional etching techniques, and the photoresist layer (not shown) is removed (e.g., via ashing or a wet chemistry as is known in the art). The interconnect feature 704 thereby is formed.

With reference to FIGS. 6A-F, after information regarding the substrate's interconnect features has been communicated to the module controller 110 (in step 605), in step 606 the module controller 110 determines whether the interconnect features formed on the substrate are acceptable. For example, the module controller 110 may determine that interconnect features such as the interconnect feature 704 are overpatterned (e.g., have dimensions that will result in interconnects that are too wide) or underpatterned (e.g., have dimensions that will result in interconnects that are too narrow). If the interconnect features on the substrate are not acceptable, the substrate is returned to the substrate cassette and the substrate is marked as a defective substrate (step 607); otherwise the process 600 proceeds to step 608.

In step 608 the substrate is transferred from the factory interface 304 to a degas chamber (e.g., one of the auxiliary chambers 316a-c) via the substrate handler 308a, and the substrate is degassed. Any suitable degas process may be employed such as a conventional heated wafer chuck or lamp heated degas process.

Once the substrate has been degassed, in step 609 the substrate is transferred to the preclean chamber 311 via the substrate handler 308a, the substrate handler 308b and the pass-through 326 (as previously described) and the substrate is precleaned. Any suitable preclean process may be employed such as a conventional preclean process (e.g., employing Ar, He, H₂ or N₂ sputtering) or a reactive preclean process (e.g., employing a fluorine based reactive species). If desired, the preclean process may be based on information regarding the interconnect features present on the substrate (e.g., information such as interconnect feature density, dimensions, profile, etc., measured by the metrology subsystem 324b of the subsystem 102). For example, sputter yield may be proportional to via size and aspect ratio, and dependent on the type of dielectric in which the via is formed. The preclean process may be adjusted to compensate for these and other factors.

Following precleaning, in step 610 the substrate is transferred to the barrier layer deposition chamber 312 via the substrate handler 308b. The module controller 110 determines a barrier layer deposition process to perform on the substrate within the barrier layer deposition chamber 312 based on the information obtained about the interconnect features formed on the substrate (e.g., interconnect feature density information, dimension information, profile information, etc.). This type of information constitutes one example of “feedforward” information. It will be understood that the barrier layer deposition process may be determined based on interconnect feature information at any time after the information is received from the metrology subsystem 324b.

The barrier layer deposition process alternatively or additionally may be based on information obtained from the integrated inspection system 324 for a barrier layer previously deposited within the barrier layer deposition chamber 312 (e.g., information such as deposited barrier layer thickness for a given deposition process, defect density or the like). This type of information constitutes one example of “feedback” information.

The module controller 110 may determine a barrier layer deposition process (or any other process described herein) in any suitable manner. For example, the module controller 110 may store (e.g., in the data storage device 206) a library of barrier layer deposition processes each of which has been optimized for a particular interconnect feature density, interconnect feature dimension, interconnect feature profile, etc. Based on feedforward information about the interconnect features on which a barrier layer is to be deposited, and/or based on other feedforward information, the module controller 110 may determine a barrier layer deposition process by selecting the “most optimal” process from the library of stored barrier layer deposition processes. Based on actual interconnect feature density, dimensions, profile, or other feedforward information, the module controller 110 may adjust various process parameters of a selected barrier layer deposition process to better match the characteristics of the substrate.

Exemplary process parameters that may be adjusted for a barrier layer deposition process include RF bias, DC power, wafer bias, chamber base pressure, processing pressure, processing temperature, processing time, processing power, etc., which may affect one or more of sheet resistance (Rₛ), reflectivity, thickness, defect density and uniformity of the deposited barrier layer.

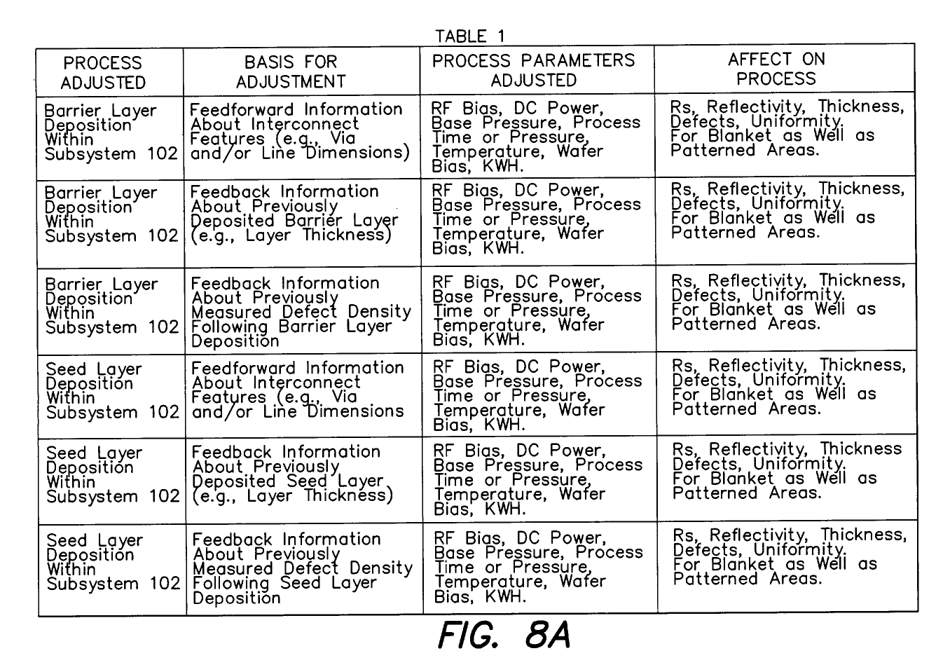

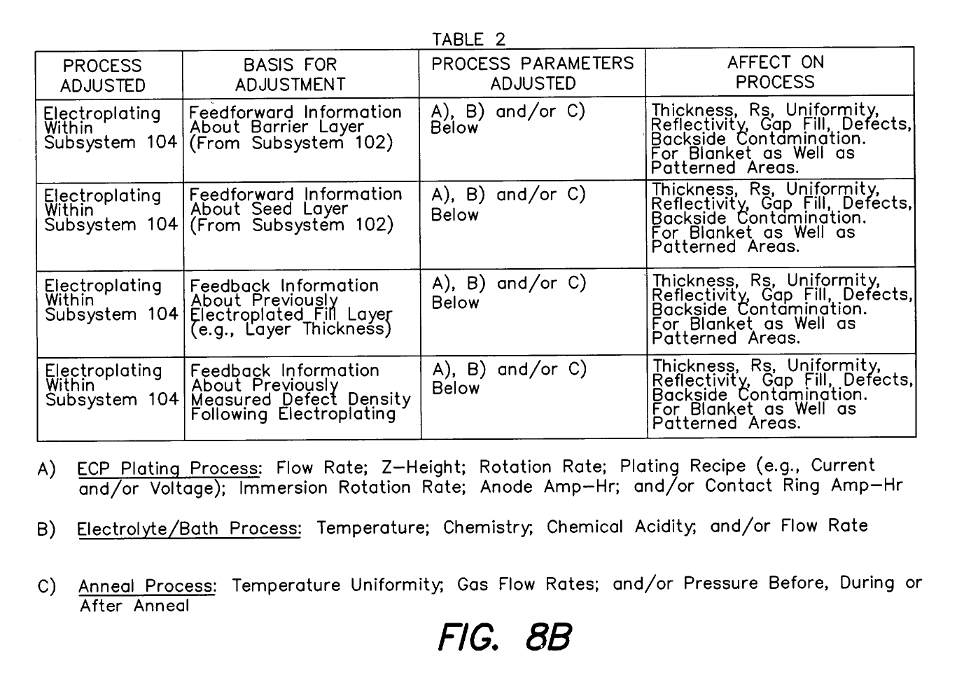

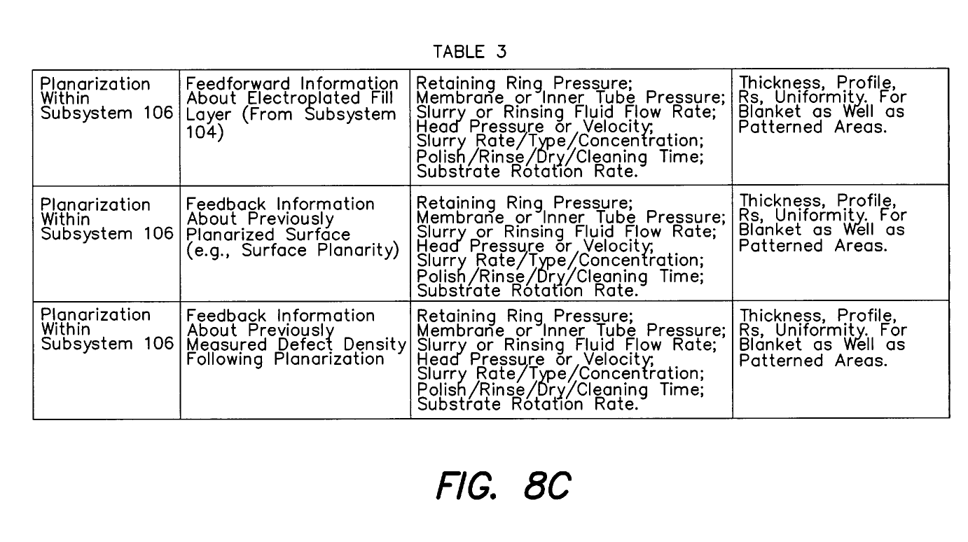

The module controller 110 may employ one or more algorithms (in addition to or in place of process libraries) for determining appropriate process parameters based on interconnect feature density, dimensions, profile, or other feedforward information. Likewise one or more process parameters may be adjusted based on feedback information regarding a barrier layer previously deposited on a substrate (e.g., if the previously deposited barrier layer is too thin, too thick, has too high of a defect density, or some other undesirable characteristic). FIG. 8A illustrates exemplary process parameters of a barrier layer deposition process that may be adjusted based on feedforward and feedback information. These process parameters may be adjusted alone or in combination when determining a barrier layer deposition process.

It will be understood that information regarding interconnect features present on a substrate may be used to affect other processing tools or subsystems such as the lithography tool and etch tool used to form the interconnect features. For example, the module controller 110 (or some other module controller) may adjust, based on feedback information about interconnect features formed by a given process, one or more parameters of the process to affect future interconnect feature formation. Adjustable process parameters of an etch tool used to etch interconnect features include, for example, etch time, etch rate, etch chemistry, etc., which may affect one or more of trench depth, critical dimension, uniformity, etc. Lithography dose of a lithographic process used to define interconnect features, as well as deposition time of a deposition process used to form an interlayer dielectric layer (in which interconnect features are formed) similarly may be adjusted based on interconnect feature feedback information.

Once a barrier layer deposition process has been determined, in step 611, the module controller 110 directs the barrier layer deposition chamber 312 to deposit a barrier layer on the substrate based on the process. FIG. 7B illustrates the silicon substrate 702 of FIG. 7A after a barrier layer 714 has been deposited thereon. In at least one embodiment, the barrier layer 714 comprises a 150-200 angstrom Ta/TaN stack. Other thicknesses and other materials also may be employed.

In step 612, the substrate is transferred from the barrier layer deposition chamber 312 to the seed layer deposition chamber 314, and the module controller 110 determines a seed layer deposition process to perform on the substrate. The seed layer deposition process may be based on the information obtained about the interconnect features formed on the substrate (e.g., interconnect feature density information, dimension information, profile information, etc.), based on information obtained about the barrier layer deposited on the substrate (e.g., barrier layer thickness) or based on other “feedforward” information.

The seed layer deposition process alternatively or additionally may be based on information obtained from the integrated inspection system 324 for a seed layer previously deposited within the seed layer deposition chamber 314 (e.g., information such as deposited seed layer thickness for a given deposition process), or based on other “feedback” information.

As with the barrier layer deposition processes, the module controller 110 may store a library of seed layer deposition processes each of which has been optimized for a particular interconnect feature density, interconnect dimension, interconnect profile, etc. Based on feedforward information about the interconnect features on which a seed layer is to be deposited, the module controller 110 may determine a seed layer deposition process and/or vary process parameters accordingly. Likewise one or more process parameters may be adjusted based on feedback information regarding a seed layer previously deposited on a substrate (e.g., if the previously deposited seed layer was too thin, too thick, has too high of a defect density or some other desirable characteristics).

Exemplary process parameters that may be adjusted for a seed layer deposition process based on feedforward information (e.g., interconnect feature information) and/or feedback information (e.g., information about a previously deposited seed layer) include, for example, RF bias, DC power, wafer bias, chamber base pressure, processing pressure processing temperature, processing time, processing power, etc., which may affect one or more of sheet resistance (Rₛ), reflectivity, thickness, defect density and uniformity of a deposited seed layer. The above process parameters may be adjusted alone or in combination when determining a seed layer deposition process to perform. FIG. 8A summarizes these process parameters.

Once a seed layer deposition process has been determined, in step 613, the module controller 110 directs the seed layer deposition chamber 314 to deposit a seed layer on the substrate based on the process.

FIG. 7C illustrates the substrate 702 following deposition of a seed layer 716 (step 613). In at least one embodiment, the seed layer 716 comprises about 1000-1500 angstroms of copper, although other materials and other thicknesses may be employed.

In step 614, the substrate is transferred from the seed layer deposition chamber 314 to the factory interface 304, and the substrate is inspected via the integrated inspection system 324. For example, the substrate may be inspected via the defect detection subsystem 324a to determine the number of defects present on the surface of the substrate following seed layer deposition and/or may be inspected within the metrology subsystem 324b to determine the thickness of the barrier layer and/or the seed layer deposited on the substrate. Information regarding the substrate then is communicated to the module controller 110.

In step 615 the module controller 110 determines whether the substrate is acceptable (e.g., if the defect density on the surface of the substrate is within an acceptable limit, if the barrier layer and/or the seed layer have an acceptable thickness, etc.). If the barrier layer and/or the seed layer are not acceptable, in step 616, the module controller 110 marks the substrate as defective and the process 600 proceeds to step 617; otherwise following step 615, the process 600 proceeds directly to step 617.

In step 617, the module controller 110 determines if all non-defective substrates in the substrate cassette have been processed. If all non-defective substrates in the substrate cassette have not been processed, the process 600 returns to step 604 to obtain another substrate from the cassette to process as described previously; otherwise the process 600 proceeds to step 618.

Following deposition of a barrier layer and a seed layer on all substrates within the substrate cassette, in step 618 the substrate cassette is transferred from the barrier/seed layer deposition subsystem 102 to the electroplating subsystem 104 (e.g., via a technician, an automated guided vehicle, an overhead carrier system, etc.). The substrate cassette then is loaded into the factory interface 404 of the electroplating subsystem 104. In step 619, a non-defective substrate is obtained from the substrate cassette (e.g., via the substrate handler 420 or 422) and, in step 620, the substrate is transferred to one of the electroplating chambers 412a-d (e.g., via the substrate handler 408 after being oriented with the orienter 424).

The module controller 110 determines an electroplating process to perform on the substrate based on information obtained from the integrated inspection system 324 of the barrier/seed layer deposition subsystem 102 and/or based on information obtained from the integrated inspection system 428 or 430 of the electroplating subsystem 104 for a substrate previously processed within one of the electroplating chambers 412a-d. For example, when step 605 is performed on a substrate, module controller 110 receives information about the density/dimensions/profile of the interconnect features present on the substrate and stores this information (e.g., with the data storage device 206) for the substrate. Likewise, when step 614 is performed on a substrate (following deposition of a barrier layer and a seed layer on the substrate) as previously described, module controller 110 receives information about the barrier layer and/or seed layer formed on the substrate (e.g., barrier layer thickness, seed layer thickness, defect density, etc.) and stores this information for the substrate. During step 620, the module controller 110 may retrieve this information for the substrate to be processed, and based on the density/dimensions/profile of the interconnect features present on the substrate, the thickness of the barrier layer and seed layer deposited on the substrate, and/or other feedforward information, the module controller 110 may select the appropriate electroplating process to be performed on the substrate (e.g., a process that deposits a fill layer that adequately fills each interconnect feature of the substrate). Information about a previously processed substrate similarly may be employed to determine the fill layer process (e.g., information such as defect density, fill layer thickness, etc., for a previously processed substrate). As with the barrier layer and seed layer deposition processes, the module controller 110 may store a library of electroplating processes each of which has been optimized for a particular interconnect feature density, interconnect feature dimension, interconnect feature profile, barrier layer thickness, barrier layer material, seed layer thickness, seed layer material, etc. Based on feedforward information about the interconnect features to be electroplated, the deposited barrier layer, the deposited seed layer, and/or the like, the module controller 110 may determine an electroplating process and/or vary process parameters of an electroplating process accordingly. Likewise, one or more process parameters of an electroplating process may be adjusted based on feedback information regarding a fill layer previously formed on a substrate (e.g., if the previously formed fill layer is too thick, too thin, has too high of a defect density or some other undesirable or non-optimized characteristic).

Exemplary process parameters that may be adjusted for an electroplating process based on feedforward information (e.g., interconnect feature information, barrier layer information, seed layer information, etc.) and/or feedback information (e.g., information about a previously formed fill layer) include, for example:

1. plating process parameters such as flow rate, Z-height (e.g., the distance between anode and substrate), substrate rotation rate, plating current, plating voltage, immersion rotation rate (e.g., the speed with which a substrate is rotated during plating), immersion voltage (e.g., the voltage applied while the substrate is being immersed in the bath), anode amp-hr, contact ring amp-hr, time, etc.;

2. electrolyte/bath process parameters such as bath temperature, chemical acidity, electrolyte/bath chemistry (e.g., organic polymer additive concentrations that affect corner rounding, reduce void formation during via filling and/or reduce delamination of plated material such as leveler, enhancer and/or suppressor concentrations, other additive concentrations, etc.), flow rate, etc.; and

3. anneal process parameters such as temperature uniformity across each substrate, gas flow rates, anneal pressure before, during or after annealing, anneal time, etc.

The above process parameters may be adjusted alone or in combination when determining an electroplating process to perform, and may affect one or more of the following characteristics of the electroplated fill layer: thickness, sheet resistance (Rₛ), uniformity, reflectivity, fill properties, defect density, contamination on substrate backside, etc. FIG. 8B summarizes these process parameters.

Once an electroplating process has been determined, in step 621, the module controller 110 directs the electroplating subsystem 104 (via one of the electroplating chambers 412a-d) to form a fill layer (e.g., copper) on the substrate (e.g., in accordance with the process determined in step 620). FIG. 7D illustrates the silicon substrate 702 following formation of a fill layer 718 thereon within one of the electroplating chambers 412a-d. In the exemplary embodiment of FIG. 7D, the fill layer 718 comprises approximately 1000 to 2000 angstroms of copper. The copper fill layer 718 may be formed by any known electroplating technique such as the interaction of a copper sulfide base solution with an H₂SO₄ solution. Other fill layer thicknesses and materials may be employed.

In step 622, the substrate is transferred from the appropriate electroplating chamber 412a-d to the integrated bevel cleaner 414. The module controller 110 then directs the integrated bevel cleaner 414 to clean the edge of the substrate. In step 623, the substrate is transferred to the spin rinse dryer 416, and the module controller 110 directs the spin rinse dryer 416 to clean/rinse/dry the substrate.

In step 624, the substrate is transferred to one of the anneal chambers 427a, 427b (e.g., via the substrate handler 408 and one of the substrate handlers 420, 422). Assuming the substrate is transferred to the first anneal chamber 427a, the module controller 110 directs the anneal chamber 427a to anneal the substrate as previously described.

In step 625 the substrate is inspected by the integrated inspection system 428 of the factory interface 404 and is returned to the substrate cassette. For example, the defect detection subsystem 428a may analyze the surface of the fill layer to determine the defect density and/or to characterize or classify defects present on the surface of the fill layer. The metrology subsystem 428b also may determine the thickness of the electroplated fill layer and/or other material parameters (e.g., film density, film quality, etc., as is known in the art). The above information is communicated to the module controller 110.

In step 626, the module controller 110 determines whether the fill layer formed on the substrate is acceptable (e.g., has the proper thickness, the proper material characteristics, a low enough defect density, etc.). If the fill layer is not acceptable, in step 627 the substrate is marked as defective and the process 600 proceeds to step 628; otherwise the process 600 proceeds directly to step 628 from step 626.

In step 628, the module controller 110 determines if all non-defective substrates in the substrate cassette have been processed. If so, the process 600 proceeds to step 629; otherwise the process 600 returns to step 619 to obtain another non-defective substrate from the substrate cassette for processing within the electroplating subsystem 104 as previously described.

In step 629, the substrate cassette is transferred from the electroplating subsystem 104 to the planarization subsystem 106. In step 630, the substrate cassette is loaded into the factory interface 504 of the planarization subsystem 106 of FIG. 5A. The substrate cassette alternatively may be transferred to the planarization subsystem 106′ of FIG. 5B, wherein a process similar to that described below may be performed.

In step 631, a non-defective substrate is obtained from the substrate cassette, and, in step 632, the substrate is transferred to the load cup 516 of the polishing system 512 (e.g., via the substrate handler 524 and the robot 506 as previously described). The module controller 110 then determines a planarization process to perform within the planarization subsystem 106 based on information obtained from the integrated inspection system 428 or 430 of the electroplating subsystem 104 for the substrate and/or based on information obtained from the integrated inspection system 528 of the planarization subsystem 106 for a substrate previously processed within the planarization subsystem 106. For example, based on information previously received from the integrated inspection system 428 or 430 of the electroplating subsystem 104 for the substrate to be planarized, the module controller 110 may determine the actual thickness of the fill layer deposited on the substrate via the electroplating subsystem 104 and may determine an appropriate planarization process based thereon (e.g., an appropriate planarization time). Likewise, based on a planarization process previously performed within the planarization subsystem 106, the module controller 110 may determine a planarization process.

As with other processes described herein, the module controller 110 may store a library of planarization processes each of which has been optimized for a particular substrate condition (e.g., a particular fill layer thickness or material, a particular polish stop layer, etc.). Based on feedforward information about the fill layer formed on a substrate, other feedforward information, feedback information about a substrate previously processed within the planarization subsystem 106, or other feedback information, the module controller 110 may select one of the stored planarization processes and/or adjust the process parameters of a planarization process to achieve a desired planarization result.

Exemplary process parameters that may be adjusted for a planarization process include, for example, retaining ring pressure, membrane and/or inner tube pressure, head pressure, other parameters that affect polish uniformity, slurry or rinsing fluid flow rate, slurry type, slurry concentration, fixed abrasive type, head velocity, substrate rotation rate, polish time, rinse time, various cleaning parameters such as scrub time, spin-rinse-dry time, megasonic cleaning time, etc. Adjusting one or more of these process parameters may affect one or more of polish rate, surface profile, surface uniformity, etc. The above process parameters may be adjusted alone or in combination when determining a planarization process to perform. FIG. 8C summarizes these process parameters.

Once a planarization process has been determined, in step 633, the module controller 110 directs the planarization subsystem 106 to planarize the substrate based on the process determined in step 632. The substrate also may be cleaned within the cleaning system 514 as previously described.

FIG. 7E illustrates the substrate 702 following planarization within the planarization subsystem 106. As shown in FIG. 7E, following planarization the barrier layer 714, the seed layer 716 and the fill layer 718 form a substantially smooth top surface. In at least one embodiment the barrier layer 714 is used as a polished stop layer. The barrier layer 714 thereafter may be removed to form the structure shown in FIG. 7E.

In step 634, the planarized substrate is transferred to the integrated inspection system 528 of the planarization subsystem 106, is inspected and is returned to the substrate cassette. For example, the substrate may be inspected within the defect detection subsystem 530a and/or the metrology subsystem 530b to determine such information as defect density, surface uniformity, etc., and this information may be communicated to the module controller 110.

In step 637, the module controller 110 determines if the planarized substrate is acceptable (e.g., has a low enough defect density, has sufficient surface smoothness/planarity, that all fill layer material to be removed has been removed, etc.). If the planarized substrate is not acceptable, the substrate is marked as defective in step 636 and the process 600 proceeds to step 637; otherwise if the planarized substrate is acceptable the process 600 proceeds directly to step 637.

In step 637 the module controller 110 determines if all non-defective substrates within the substrate cassette have been planarized. If so, the process 600 ends in step 638; otherwise the process 600 returns to step 631 to obtain another non-defective substrate from the substrate cassette and to planarize the substrate within the planarization subsystem 106 as described previously.

It will be understood that the process 600 is merely exemplary of one interconnect formation process that may be performed within the inventive system 100 of FIGS. 1A and 1B. Other interconnect formation processes also may be performed by the system 100. While in process 600 every substrate processed is inspected following barrier/seed layer deposition, electroplating and planarization, it will be understood that fewer than every substrate may be inspected following barrier/seed layer deposition, electroplating and/or planarization. Further, the material layers and material layer thicknesses described herein are merely exemplary and other suitable materials and material layer thicknesses may be similarly employed.

The embedded module controllers (EMC's) 102a-106a and/or the automated process control (APC) modules 102b-106b may contain computer program code and/or data structures for performing one or more of the steps 601-638 of process 600 rather than or in addition to the module controller 110. The program 208 may contain computer program code and/or data structures for performing one or more of the steps 601-638 of process 600.

The foregoing description discloses only exemplary embodiments of the invention. Modifications of the above disclosed apparatus and method which fall within the scope of the invention will be readily apparent to those of ordinary skill in the art. For instance, other processes than those described herein may be employed during barrier layer, seed layer or fill layer formation, and/or during planarization. Other processing subsystems than those described herein may be similarly configured with integrated inspection systems. During substrate inspection, all or a portion of each substrate may be inspected (e.g., a pre-programmed or predetermined part of a wafer die, 5-10 wafer die, etc.). Separate subsystems for depositing barrier layers and seed layers may be employed. While FIGS. 8A-C illustrate exemplary process parameters that may be adjusted based on feedforward and feedback information, it will be understood that numerous other process parameters similarly may be adjusted. For example, if a defect density following a process is too high within a certain subsystem, the module controller 110 and/or one of the EMC's 102a-106a may perform a cleaning process within the subsystem, or direct an increase in the season time used following subsystem maintenance so as to reduce defect density.

The module controller 110 and/or the EMC's 102a-106a may be employed to monitor subsystem health. For example, a software diagnostic tool such as Smart (distributed by Applied Materials, Inc.) which monitors equipment signals (e.g., signals from mass flow controllers, throttle valves, radio frequency sources, etc.) and analyzes such signals for drift may be used in conjunction with the module controller 110, and/or the embedded module controllers (EMC's) 102a-106a by having the module controllers provide other process drift information to the software diagnostic tool, or by having the module controllers adjust process parameters to compensate for process drift (e.g., by increasing process time, flow rates, chamber pressure, etc.). Integrated inspection systems need not be employed by all subsystems.

Accordingly, while the present invention has been disclosed in connection with exemplary embodiments thereof, it should be understood that other embodiments may fall within the spirit and scope of the invention, as defined by the following claims.

The invention claimed is

1. A system configured to form an interconnect on a substrate, the system comprising:
a barrier/seed layer deposition subsystem configured to deposit a barrier layer and a seed layer on a substrate, the barrier/seed layer deposition subsystem having an integrated inspection system configured to inspect the substrate;
an electroplating subsystem configured to receive the substrate after the seed layer has been deposited on the substrate and to deposit a fill layer on the substrate, the electroplating subsystem having an integrated inspection system configured to inspect the substrate;
a planarization subsystem configured to receive the substrate after the fill layer has been deposited on the substrate and to planarize the substrate; and
a controller coupled to the barrier/seed layer deposition subsystem, the electroplating subsystem and the planarization subsystem, the controller having computer program code configured to communicate with each subsystem and to perform the steps of:
receiving information about a substrate processed within the barrier/seed layer deposition subsystem from the inspection system of the barrier/seed layer deposition subsystem;
determining an electroplating process to perform within the electroplating subsystem based at least in part on the information received from the inspection system of the barrier/seed layer deposition subsystem;
directing the electroplating subsystem to deposit a fill layer on the substrate based on the electroplating process;
receiving information about the fill layer deposited on the substrate from the inspection system of the electroplating subsystem;
determining a planarization process to perform within the planarization subsystem based at least in part on the information received from the inspection system of the electroplating subsystem; and
directing the planarization subsystem to planarize the substrate based on the planarization process.

2. The system of claim 1 wherein receiving information about a substrate processed within the barrier/seed layer deposition subsystem comprises receiving information about a defect density of a seed layer deposited on the substrate within the barrier/seed layer deposition subsystem; and
wherein determining an electroplating process to perform within the electroplating subsystem comprises determining an electroplating process based at least in part on the defect density of the seed layer.

3. The system of claim 2 wherein determining an electroplating process comprises determining at least one of a plating parameter, an electrolyte/bath parameter and an annealing parameter of the electroplating process.

4. The system of claim 1 wherein receiving information about a substrate processed within the barrier/seed layer deposition subsystem comprises receiving information about a thickness of a seed layer deposited within the barrier/seed layer deposition subsystem on the substrate; and
wherein determining an electroplating process to perform within the electroplating subsystem comprises determining an electroplating process based at least in part on the thickness of the seed layer.

5. The system of claim 4 wherein determining an electroplating process comprises determining at least one of a plating parameter, an electrolyte/bath parameter and an annealing parameter of the electroplating process.

6. The system of claim 1 wherein receiving information about a substrate processed within the barrier/seed layer deposition subsystem comprises receiving information about a defect density of a barrier layer deposited within the barrier/seed layer deposition subsystem on the substrate; and
wherein determining an electroplating process to perform within the electroplating subsystem comprises determining an electroplating process based at least in part on the defect density of the barrier layer.

7. The system of claim 6 wherein determining an electroplating process comprises determining at least one of a plating parameter, an electrolyte/bath parameter and an annealing parameter of the electroplating process.

8. The system of claim 1 wherein receiving information about a substrate processed within the barrier/seed layer deposition subsystem comprises receiving information about a thickness of a barrier layer deposited within the barrier/seed layer deposition subsystem on the substrate; and
wherein determining an electroplating process to perform within the electroplating subsystem comprises determining an electroplating process based at least in part on the thickness of the barrier layer.

9. The system of claim 8 wherein determining an electroplating process comprises determining at least one of a plating parameter, an electrolyte/bath parameter and an annealing parameter of the electroplating process.

10. The system of claim 1 wherein receiving information about the fill layer deposited on the substrate from the inspection system of the electroplating subsystem comprises receiving information about a defect density of the fill layer; and
wherein determining a planarization process to perform within the planarization subsystem comprises determining a planarization process to perform based at least in part on the defect density of the fill layer.

11. The system of claim 10 wherein determining a planarization process comprises determining at least one of retaining ring pressure, membrane pressure, inner tube pressure, rinsing fluid flow rate, head pressure, head velocity, substrate rotation rate, slurry flow rate, slurry type, slurry concentration, polish time and rinse time of the planarization process.

12. The system of claim 1 wherein receiving information about the fill layer deposited on the substrate from the inspection system of the electroplating subsystem comprises receiving information about the thickness of the fill layer; and
wherein determining a planarization process to perform within the planarization subsystem comprises determining a planarization process to perform based at least in part on the thickness of the fill layer.

13. The system of claim 12 wherein determining a planarization process comprises determining at least one of retaining ring pressure, membrane pressure, inner tube pressure, rinsing fluid flow rate, head pressure, head velocity, substrate rotation rate, slurry flow rate, slurry type, slurry concentration, polish time and rinse time of the planarization process.

14. The system of claim 1 wherein the controller further comprises computer program code configured to perform the steps of:
determining a deposition process to perform within the barrier/seed layer deposition subsystem based at least in part on information received from the inspection system of the barrier/seed layer deposition subsystem about a substrate previously processed within the barrier/seed layer deposition subsystem; and
directing the barrier/seed layer deposition subsystem to process a substrate based on the deposition process.

15. The system of claim 14 wherein determining a deposition process to perform comprises:
receiving information about a defect density of a seed layer deposited within the barrier/seed layer deposition subsystem on the previously processed substrate; and
determining a deposition process to perform based at least in part on the defect density of the seed layer.

16. The system of claim 15 wherein determining a deposition process comprises determining at least one of RF bias, DC power, wafer bias, chamber base pressure, processing pressure, processing temperature, processing time and processing power of a seed layer deposition process.

17. The system of claim 14 wherein determining a deposition process to perform comprises:
receiving information about a thickness of a seed layer deposited within the barrier/seed layer deposition subsystem on the previously processed substrate; and
determining a deposition process to perform based at least in part on the thickness of the seed layer.

18. The system of claim 17 wherein determining a deposition process comprises determining at least one of RF bias, DC power, wafer bias, chamber base pressure, processing pressure, processing temperature, processing time and processing power of a seed layer deposition process.

19. The system of claim 14 wherein determining a deposition process to perform comprises:
receiving information about a defect density of a barrier layer deposited within the barrier/seed layer deposition subsystem on the previously processed substrate; and
determining a deposition process to perform based at least in part on the defect density of the barrier layer.

20. The system of claim 19 wherein determining a deposition process comprises determining at least one of RF bias, DC power, wafer bias, chamber base pressure, processing pressure, processing temperature, processing time and processing power of a barrier layer deposition process.

21. The system of claim 14 wherein determining a deposition process to perform comprises:
receiving information about a thickness of a barrier layer deposited within the barrier/seed layer deposition subsystem on the previously processed substrate; and
determining a deposition process to perform based at least in part on the thickness of the barrier layer.

22. The system of claim 21 wherein determining a deposition process comprises determining at least one of RF bias, DC power, wafer bias, chamber base pressure, processing pressure, processing temperature, processing time and processing power of a barrier layer deposition process.

23. The system of claim 1 wherein determining an electroplating process to perform within the electroplating subsystem comprises determining an electroplating process based at least in part on information received from the inspection system of the electroplating subsystem about a substrate previously processed within the electroplating subsystem.

24. The system of claim 23 wherein determining an electroplating process to perform comprises:
receiving information about a defect density of a fill layer deposited on the previously processed substrate; and
determining an electroplating process based at least in part on the defect density of the fill layer.

25. The system of claim 24 wherein determining an electroplating process comprises determining at least one of a plating parameter, an electrolyte/bath parameter and an annealing parameter of the electroplating process.

26. The system of claim 23 wherein determining an electroplating process to perform comprises:
receiving information about a thickness of a fill layer deposited on the previously processed substrate; and
determining an electroplating process based at least in part on the thickness of the fill layer.

27. The system of claim 26 wherein determining an electroplating process comprises determining at least one of a plating parameter, an electrolyte/bath parameter and an annealing parameter of the electroplating process.

28. The system of claim 1 wherein the planarization subsystem includes an integrated inspection system configured to inspect the substrate after the substrate has been planarized; and
wherein the controller further comprises computer program code configured to perform the step of receiving information about the planarized substrate from the inspection system of the planarization subsystem.

29. The system of claim 28 wherein determining a planarization process to perform within the planarization subsystem comprises determining a planarization process based at least in part on information received from the inspection system of the planarization subsystem about a substrate previously processed within the planarization subsystem.

30. The system of claim 29 wherein determining a planarization process to perform comprises:
receiving information about a defect density of the previously processed substrate; and
determining a planarization process based at least in part on the defect density of the previously processed substrate.

31. The system of claim 30 wherein determining a planarization process comprises determining at least one of retaining ring pressure, membrane pressure, inner tube pressure, rinsing fluid flow rate, head pressure, head velocity, substrate rotation rate, slurry flow rate, slurry type, slurry concentration, polish time and rinse time of the planarization process.

32. The system of claim 29 wherein determining a planarization process to perform comprises:
receiving information about a surface planarity of the previously processed substrate; and
determining a planarization process based at least in part on the surface planarity of the previously processed substrate.

33. The system of claim 32 wherein determining a planarization process comprises determining at least one of retaining ring pressure, membrane pressure, inner tube pressure, rinsing fluid flow rate, head pressure, head velocity, substrate rotation rate, slurry flow rate, slurry type, slurry concentration, polish time and rinse time of the planarization process.

34. The system of claim 1 wherein the inspection system of the barrier/seed layer deposition subsystem is configured to inspect an interconnect feature formed on a substrate before a barrier layer is deposited on the substrate within the barrier/seed layer deposition subsystem; and
wherein the controller further comprises computer program code configured to perform the steps of:
receiving information about the interconnect feature from the inspection system of the barrier/seed layer deposition subsystem;
determining a deposition process to perform within the barrier/seed layer deposition subsystem based at least in part on the information received about the interconnect feature; and
directing the barrier/seed layer deposition subsystem to perform the deposition process.

35. The system of claim 34 wherein determining a deposition process comprises determining a barrier layer deposition process by determining at least one of RF bias, DC power, wafer bias, chamber base pressure, processing pressure, processing temperature, processing time and processing power of the barrier layer deposition process.

36. The system of claim 34 wherein determining a deposition process comprises determining a seed layer deposition process by determining at least one of RF bias, DC power, wafer bias, chamber base pressure, processing pressure, processing temperature, processing time and processing power of the seed layer deposition process.

37. The system of claim 1 wherein the inspection system of at least one of the subsystems is coupled to a factory interface of the subsystem.

38. The system of claim 1 wherein the inspection system of at least one of the subsystems comprises a metrology system.

39. The system of claim 1 wherein the inspection system of at least one of the subsystems comprises a defect detection system.

40. The system of claim 1 wherein the inspection system of at least one of the subsystems comprises both a defect detection system and a metrology system.

41. The system of claim 1 wherein the barrier/seed layer deposition subsystem comprises both a barrier layer deposition subsystem having an integrated inspection system and a seed layer deposition subsystem having an integrated inspection system.

42. The system of claim 1 wherein each subsystem includes an embedded module controller configured to determine a process to perform within the subsystem based at least in part on feedback information about a substrate previously processed within the subsystem.

43. The system of claim 1 wherein the controller further comprises computer program code configured to perform the steps of:
receiving information about a defect density of a barrier layer deposited within the barrier/seed layer deposition subsystem; and
determining at least one of a season time and a clean time for a barrier layer deposition chamber based on the defect density of the barrier layer.

44. The system of claim 1 wherein the controller further comprises computer program code configured to perform the steps of:
receiving information about a defect density of a seed layer deposited within the barrier/seed layer deposition subsystem; and
determining at least one of a season time and a clean time for a seed layer deposition chamber based on the defect density of the seed layer.

45. The system of claim 1 wherein the controller further comprises computer program code configured to perform the steps of:
receiving information about a defect density of a fill layer deposited within the electroplating subsystem; and
determining at least one of a season time and a clean time for an electroplating chamber based on the defect density of the fill layer.

46. The system of claim 1 wherein the controller further comprises computer program code configured to perform the steps of:
receiving information about a defect density of a substrate planarized within the planarization subsystem; and
determining a rinse time for the planarization subsystem based on the defect density.

47. A method of forming an interconnect on a substrate comprising:
receiving information about a substrate processed within a barrier/seed layer deposition subsystem from an integrated inspection system of the barrier/seed layer deposition subsystem;
determining an electroplating process to perform within an electroplating subsystem based at least in part on the information received from the inspection system of the barrier/seed layer deposition subsystem;
directing the electroplating subsystem to deposit a fill layer on the substrate based on the electroplating process;
receiving information about the fill layer deposited on the substrate from an integrated inspection system of the electroplating subsystem;
determining a planarization process to perform within a planarization subsystem based at least in part on the information received from the inspection system of the electroplating subsystem; and
directing the planarization subsystem to planarize the substrate based on the planarization process.

48. The method of claim 47 further comprising receiving information about the planarized substrate from an inspection system of the planarization subsystem.

49. The method of claim 48 further comprising:
determining a deposition process to perform within the barrier/seed layer deposition subsystem based at least in part on information received from the inspection system of the barrier/seed layer deposition subsystem about a substrate previously processed within the barrier/seed layer deposition subsystem;
wherein determining an electroplating process to perform within an electroplating subsystem comprises determining an electroplating process based at least in part on information received from the inspection system of the electroplating subsystem about a substrate previously processed within the electroplating subsystem; and
wherein determining a planarization process to perform within a planarization subsystem comprises determining a planarization process based at least in part on information received from the inspection system of the planarization subsystem about a substrate previously processed within the planarization subsystem.

50. The method of claim 47 further comprising:
receiving information from the inspection system of the barrier/seed layer deposition subsystem about an interconnect feature formed on a substrate before a barrier layer is deposited on the substrate within the barrier/seed layer deposition subsystem;
determining a deposition process to perform within the barrier/seed layer deposition subsystem based at least in part on the information received from the inspection system of the barrier/seed layer deposition subsystem about the interconnect feature; and
directing the barrier/seed layer deposition subsystem to perform the deposition process.

51. A computer program product comprising:
a medium readable by a computer, the computer readable medium having computer program code adapted to:
receive information about a substrate processed within a barrier/seed layer deposition subsystem from an integrated inspection system of the barrier/seed layer deposition subsystem;
determine an electroplating process to perform within an electroplating subsystem based at least in part on the information received from the inspection system of the barrier/seed layer deposition subsystem;
direct the electroplating subsystem to deposit a fill layer on the substrate based on the electroplating process;
receive information about the fill layer deposited on the substrate from an integrated inspection system of the electroplating subsystem;
determine a planarization process to perform within a planarization subsystem based at least in part on the information received from the inspection system of the electroplating subsystem; and
direct the planarization subsystem to planarize the substrate based on the planarization process.

52. The computer program product of claim 51 further comprising computer program code adapted to receive information about the planarized substrate from an inspection system of the planarization subsystem.

53. The computer program product of claim 52 further comprising:
computer program code adapted to determine a deposition process to perform within the barrier/seed layer deposition subsystem based at least in part on information received from the inspection system of the barrier/seed layer deposition subsystem about a substrate previously processed within the barrier/seed layer deposition subsystem;
wherein the computer program code adapted to determine an electroplating process to perform within an electroplating subsystem comprises computer program code adapted to determine an electroplating process based at least in part on information received from the inspection system of the electroplating subsystem about a substrate previously processed within the electroplating subsystem; and
wherein the computer program code adapted to determine a planarization process to perform within a planarization subsystem comprises computer program code adapted to determine a planarization process based at least in part on information received from the inspection system of the planarization subsystem about a substrate previously processed within the planarization subsystem.

54. The computer program product of claim 51 further comprising computer program code adapted to:
receive information from the inspection system of the barrier/seed layer deposition subsystem about an interconnect feature formed on a substrate before a barrier layer is deposited on the substrate within the barrier/seed layer deposition subsystem;
determine a deposition process to perform within the barrier/seed layer deposition subsystem based at least in part on the information received from the inspection system of the barrier/seed layer deposition subsystem about the interconnect feature; and
direct the barrier/seed layer deposition subsystem to perform the deposition process.

55. A system for forming an interconnect on a substrate comprising:
means for determining a deposition process to perform within a barrier/seed layer deposition subsystem;
means for directing the barrier/seed layer deposition subsystem to perform the deposition process so as to deposit a material layer on a substrate;
means for receiving information about the deposited material layer from an integrated inspection system of the barrier/seed layer deposition subsystem;
means for determining an electroplating process to perform within an electroplating subsystem based at least in part on the information received from the inspection system of the barrier/seed layer deposition subsystem;
means for directing the electroplating subsystem to deposit a fill layer on the substrate based on the electroplating process;
means for receiving information about the fill layer deposited on the substrate from an integrated inspection system of the electroplating subsystem;
means for determining a planarization process to perform within a planarization subsystem based at least in part on the information received from the inspection system of the electroplating subsystem; and
means for directing the planarization subsystem to planarize the substrate based on the planarization process.

56. A method for forming an interconnect on a substrate comprising:
a step for determining a deposition process to perform within a barrier/seed layer deposition subsystem;
a step for directing the barrier/seed layer deposition subsystem to perform the deposition process so as to deposit a material layer on a substrate;
a step for receiving information about the deposited material layer from an integrated inspection system of the barrier/seed layer deposition subsystem;
a step for determining an electroplating process to perform within an electroplating subsystem based at least in part on the information received from the inspection system of the barrier/seed layer deposition subsystem;
a step for directing the electroplating subsystem to deposit a fill layer on the substrate based on the electroplating process;
a step for receiving information about the fill layer deposited on the substrate from an integrated inspection system of the electroplating subsystem;
a step for determining a planarization process to perform within a planarization subsystem based at least in part on the information received from the inspection system of the electroplating subsystem; and
a step for directing the planarization subsystem to planarize the substrate based on the planarization process.

57. A system configured to form an interconnect on a substrate, the system comprising:
a barrier/seed layer deposition subsystem configured to deposit a barrier layer and a seed layer on a substrate, the barrier/seed layer deposition subsystem having an integrated inspection system configured to inspect the substrate;
an electroplating subsystem configured to receive the substrate after the seed layer has been deposited on the substrate and to deposit a fill layer on the substrate, the electroplating subsystem having an integrated inspection system configured to inspect the substrate;
a planarization subsystem configured to receive the substrate after the fill layer has been deposited on the substrate and to planarize the substrate; and
a controller coupled to the barrier/seed layer deposition subsystem, the electroplating subsystem and the planarization subsystem, the controller having computer program code configured to communicate with each subsystem and to perform the steps of:
receiving information about a thickness of a material layer deposited on a substrate within the barrier/seed layer deposition subsystem from the inspection system of the barrier/seed layer deposition subsystem;
determining an electroplating process to perform within the electroplating subsystem based at least in part on the information received from the inspection system of the barrier/seed layer deposition subsystem about the thickness of the deposited material layer;
directing the electroplating subsystem to deposit a fill layer on the substrate based on the electroplating process;
receiving information about a thickness of the fill layer deposited on the substrate from the inspection system of the electroplating subsystem;
determining a planarization process to perform within the planarization subsystem based at least in part on the information received from the inspection system of the electroplating subsystem about the thickness of the fill layer; and
directing the planarization subsystem to planarize the substrate based on the planarization process.

58. The system of claim 57 wherein the planarization subsystem includes an integrated inspection system configured to inspect a substrate after the substrate is planarized; and
wherein the controller further comprises computer program code configured to perform the step of receiving information about the planarized substrate from the inspection system of the planarization subsystem.

59. The system of claim 58 wherein the controller further comprises computer program code configured to perform the steps of:
determining a deposition process to perform within the barrier/seed layer deposition subsystem based at least in part on information received from the inspection system of the barrier/seed layer deposition subsystem about a substrate previously processed within the barrier/seed layer deposition subsystem;
determining an electroplating process based at least in part on information received from the inspection system of the electroplating subsystem about a substrate previously processed within the electroplating subsystem; and
determining a planarization process based at least in part on information received from the inspection system of the planarization subsystem about a substrate previously processed within the planarization subsystem.

60. A method of forming an interconnect on a substrate comprising:
receiving information about a thickness of a material layer deposited on a substrate within a barrier/seed layer deposition subsystem from an integrated inspection system of the barrier/seed layer deposition subsystem;
determining an electroplating process to perform within an electroplating subsystem based at least in part on the information received from the inspection system of the barrier/seed layer deposition subsystem about the thickness of the material layer;
directing the electroplating subsystem to deposit a fill layer on the substrate based on the electroplating process;
receiving information about a thickness of the fill layer deposited on the substrate from an integrated inspection system of the electroplating subsystem;
determining a planarization process to perform within a planarization subsystem based at least in part on the information received from the inspection system of the electroplating subsystem about the thickness of the fill layer; and
directing the planarization subsystem to planarize the substrate based on the planarization process.

61. The method of claim 60 further comprising receiving information about the planarized substrate from an inspection system of the planarization subsystem.

62. The method of claim 61 further comprising:
determining a deposition process to perform within the barrier/seed layer deposition subsystem based at least in part on information received from the inspection system of the barrier/seed layer deposition subsystem about a substrate previously processed within the barrier/seed layer deposition subsystem;
determining an electroplating process based at least in part on information received from the inspection system of the electroplating subsystem about a substrate previously processed within the electroplating subsystem; and
determining a planarization process based at least in part on information received from the inspection system of the planarization subsystem about a substrate previously processed within the planarization subsystem.

63. The method of claim 60 further comprising receiving information about an interconnect feature formed on the substrate from the inspection system of the barrier/seed layer deposition subsystem, and wherein determining a deposition process comprises determining a deposition process based at least in part on the information about the interconnect feature received from the inspection system of the barrier/seed layer deposition subsystem.

64. A computer program product comprising:
a medium readable by a computer, the computer readable medium having computer program code adapted to:
receive information about a thickness of a material layer deposited on a substrate within a barrier/seed layer deposition subsystem from an integrated inspection system of the barrier/seed layer deposition subsystem;
determine an electroplating process to perform within an electroplating subsystem based at least in part on the information received from the inspection system of the barrier/seed layer deposition subsystem about the thickness of the material layer;
direct the electroplating subsystem to deposit a fill layer on the substrate based on the electroplating process;
receive information about a thickness of the fill layer deposited on the substrate from an integrated inspection system of the electroplating subsystem;
determine a planarization process to perform within a planarization subsystem based at least in part on the information received from the inspection system of the electroplating subsystem about the thickness of the fill layer; and
direct the planarization subsystem to planarize the substrate based on the planarization process.

65. An apparatus configured to form an interconnect on a substrate, the apparatus comprising:
a controller configured to communicate with a plurality of subsystems including: (1) a barrier/seed layer deposition subsystem configured to deposit a barrier layer and a seed layer on a substrate and having an integrated inspection system; (2) an electroplating subsystem configured to form a fill layer on the substrate and having an integrated inspection system; and (3) a planarization subsystem configured to planarize the substrate and having an integrated inspection system; and
a data structure which causes the controller to control the formation of an interconnect via one or more communications with the plurality of subsystems and via one or more communications with the inspection systems of the barrier/seed layer deposition subsystem, the electroplating subsystem and the planarization subsystem.

66. The apparatus of claim 65 wherein the one or more communications with the inspection systems of the barrier/seed layer deposition subsystem and the electroplating subsystem comprise receiving feedforward information.

67. The apparatus of claim 65 wherein the one or more communications with the inspection systems of the barrier/seed layer deposition subsystem, the electroplating subsystem and planarization subsystem comprise receiving feedback information.

68. A system comprising:
a barrier/seed layer deposition subsystem configured to deposit a barrier layer and a seed layer on a substrate, the barrier/seed layer deposition subsystem having an integrated inspection system configured to inspect the substrate;
an electroplating subsystem configured to receive the substrate after the seed layer has been deposited on the substrate and to deposit a fill layer on the substrate, the electroplating subsystem having an integrated inspection system configured to inspect the substrate; and
a controller coupled to the barrier/seed layer deposition subsystem and the electroplating subsystem, the controller having computer program code configured to communicate with each subsystem and to perform the steps of:
receiving information about a substrate processed within the barrier/seed layer deposition subsystem from the inspection system of the barrier/seed layer deposition subsystem;
determining an electroplating process to perform within the electroplating subsystem based at least in part on the information received from the inspection system of the barrier/seed layer deposition subsystem; and
directing the electroplating subsystem to deposit a fill layer on the substrate based on the electroplating process.

69. A method comprising:
receiving information about a substrate processed within a barrier/seed layer deposition subsystem from an integrated inspection system of the barrier/seed layer deposition subsystem;
determining an electroplating process to perform within an electroplating subsystem based at least in part on the information received from the inspection system of the barrier/seed layer deposition subsystem; and
directing the electroplating subsystem to deposit a fill layer on the substrate based on the electroplating process.

70. A computer program product comprising:
a medium readable by a computer, the computer readable medium having computer program code adapted to:
receive information about a substrate processed within a barrier/seed layer deposition subsystem from an integrated inspection system of the barrier/seed layer deposition subsystem;
determine an electroplating process to perform within an electroplating subsystem based at least in part on the information received from the inspection system of the barrier/seed layer deposition subsystem; and
direct the electroplating subsystem to deposit a fill layer on the substrate based on the electroplating process.

71. A system comprising:
an electroplating subsystem configured to receive a substrate after a seed layer has been deposited on the substrate and to deposit a fill layer on the substrate, the electroplating subsystem having an integrated inspection system configured to inspect the substrate;
a planarization subsystem configured to receive the substrate after the fill layer has been deposited on the substrate and to planarize the substrate; and
a controller coupled to the electroplating subsystem and the planarization subsystem, the controller having computer program code configured to communicate with each subsystem and to perform the steps of:
receiving information about the fill layer deposited on the substrate from the inspection system of the electroplating subsystem;
determining a planarization process to perform within the planarization subsystem based at least in part on the information received from the inspection system of the electroplating subsystem; and
directing the planarization subsystem to planarize the substrate based on the planarization process.

72. A method comprising:
receiving information about a fill layer deposited on a substrate from an integrated inspection system of an electroplating subsystem;
determining a planarization process to perform within a planarization subsystem based at least in part on the information received from the inspection system of the electroplating subsystem; and
directing the planarization subsystem to planarize the substrate based on the planarization process.

73. A computer program product comprising:
a medium readable by a computer, the computer readable medium having computer program code adapted to:
receive information about a fill layer deposited on a substrate from an integrated inspection system of an electroplating subsystem;
determine a planarization process to perform within a planarization subsystem based at least in part on the information received from the inspection system of the electroplating subsystem; and
direct the planarization subsystem to planarize the substrate based on the planarization process.

74. A system configured to form an interconnect on a substrate, the system comprising:
a barrier/seed layer deposition subsystem configured to deposit a barrier layer and a seed layer on a substrate, the barrier/seed layer deposition subsystem having an integrated inspection system configured to inspect the substrate;
an electroplating subsystem configured to receive the substrate after the seed layer has been deposited on the substrate and to deposit a fill layer on the substrate, the electroplating subsystem having an integrated inspection system configured to inspect the substrate;
a planarization subsystem configured to receive the substrate after the fill layer has been deposited on the substrate and to planarize the substrate, the planarization subsystem having an integrated inspection system configured to inspect the substrate; and
a controller coupled to the barrier/seed layer deposition subsystem, the electroplating subsystem and the planarization subsystem, the controller having computer program code configured to communicate with each subsystem and to perform the steps of:
determining a deposition process to perform within the barrier/seed layer deposition subsystem based at least in part on information received from the inspection system of the barrier/seed layer deposition subsystem about a substrate previously processed within the barrier/seed layer deposition subsystem;
directing the barrier/seed layer deposition subsystem to perform the deposition process on a substrate;
determining an electroplating process based at least in part on information received from the inspection system of the electroplating subsystem about a substrate previously processed within the electroplating subsystem;
directing the electroplating subsystem to perform the electroplating process on the substrate;
determining a planarization process based at least in part on information received from the inspection system of the planarization subsystem about a substrate previously processed within the planarization subsystem; and
directing the planarization subsystem to perform the planarization process on the substrate.

75. A method for forming an interconnect on a substrate comprising:
determining a deposition process to perform within a barrier/seed layer deposition subsystem based at least in part on information received from an integrated inspection system of the barrier/seed layer deposition subsystem about a substrate previously processed within the barrier/seed layer deposition subsystem;
directing the barrier/seed layer deposition subsystem to perform the deposition process on a substrate;
determining an electroplating process based at least in part on information received from an integrated inspection system of an electroplating subsystem about a substrate previously processed within the electroplating subsystem;
directing the electroplating subsystem to perform the electroplating process on the substrate;
determining a planarization process based at least in part on information received from an integrated inspection system of a planarization subsystem about a substrate previously processed within the planarization subsystem; and
directing the planarization subsystem to perform the planarization process on the substrate.

76. A computer program product comprising:
a medium readable by a computer, the computer readable medium having computer program code adapted to:
determine a deposition process to perform within a barrier/seed layer deposition subsystem based at least in part on information received from an integrated inspection system of the barrier/seed layer deposition subsystem about a substrate previously processed within the barrier/seed layer deposition subsystem;
direct the barrier/seed layer deposition subsystem to perform the deposition process on a substrate;
determine an electroplating process based at least in part on information received from an integrated inspection system of an electroplating subsystem about a substrate previously processed within the electroplating subsystem;
direct the electroplating subsystem to perform the electroplating process on the substrate;
determine a planarization process based at least in part on information received from an integrated inspection system of a planarization subsystem about a substrate previously processed within the planarization subsystem; and
direct the planarization subsystem to perform the planarization process on the substrate.
